(19) United States
(12) Patent Application Publication
(10) Pub. No.: US 2025/0136890 A1
(43) Pub. Date: May 1, 2025

(54) EXTRACTION OF ONE OR MORE OILS

(71) Applicant: Energy and Environmental Research Center Foundation, Grand Forks, ND (US)

(72) Inventors: Jasmine Oleksik, Grand Forks, ND (US); Chad A. Wocken, Grand Forks, ND (US)

(21) Appl. No.: 18/495,046

(22) Filed: Oct. 26, 2023

(51) Int. Cl. C11B 1/10; A23D 9/04; C11B 1/02; C11B 1/04; C11B 1/06

(52) U.S. Cl. CPC C11B 1/104; A23D 9/04; C11B 1/025; C11B 1/04; C11B 1/06

(57) ABSTRACT

A method of extracting one or more oils includes compressing CO₂ gas produced by fermentation of a grain, to form supercritical CO₂ (scCO₂), wherein the fermentation of the grain forms a spent grain. The method includes extracting the one or more oils from the spent grain with the scCO₂. The method includes separating the oil and the scCO₂.

### BACKGROUND

Conventional technology for corn oil extraction at dry mill ethanol facilities is primarily centrifugation following distillation for ethanol collection. The currently employed oil extraction methods only recover approximately 50% of the oil in the process stream. The remaining oil is contained in the distillers grain, which is typically sold as a by-product for animal feed. Although supercritical carbon dioxide (scCO₂)-facilitated solvent extraction has been used to extract corn oil, the costs of carbon dioxide (CO₂) conditioning for scCO₂ production, such as capital investment for compression and storage, are prohibitive.

### SUMMARY OF THE INVENTION

Various aspects of the present invention provide a method of extracting one or more oils from an oil-bearing material. The method includes compressing CO₂ to form supercritical CO₂ (scCO₂), and/or collecting scCO₂. The method also includes extracting one or more oils from an oil-bearing material comprising a plant product, algae, a waste product, an animal product, or a combination thereof.

Various aspects of the present invention provide a method of extracting one or more oils from a fermented grain. The method includes compressing CO₂ gas produced or available on-site to form supercritical CO₂ (scCO₂), and/or collecting scCO₂ produced or available on-site. The method also includes extracting one or more oils from the fermented grain with the scCO₂.

Various aspects of the present invention provide a method of extracting one or more oils from a fermented grain. The method includes compressing CO₂ gas produced by fermentation of a grain, to form supercritical CO₂ (scCO₂), wherein the fermentation of the grain forms a spent grain. The method includes extracting the one or more oils from the spent grain with the scCO₂. The method also includes separating the oil and the scCO₂.

Various aspects of the present invention provide a method of extracting one or more oils. The method includes compressing CO₂ gas produced by fermentation of corn, to form supercritical CO₂ (scCO₂), wherein the fermentation of the corn forms a used corn including dried distillers grains with solubles (DDGS), whole stillage (WS), or a combination thereof. The method includes extracting the one or more oils from the used corn with the scCO₂, wherein the fermentation of the grain and the extraction of the spent grain are performed within two miles of one another. The method includes depressurizing the scCO₂, to form a used CO₂ and an extracted corn oil. The method also includes recycling the used CO₂ stream for reuse in the method as a portion of the scCO₂ used for the extracting of the one or more oils from the used corn.

Various aspects of the present invention provide a system for of extracting one or more oils. The system includes a compressor configured to compress CO₂ formed by fermentation of a grain, to form supercritical CO₂ (scCO₂), wherein the fermentation of the grain forms a spent grain. The system includes an extractor configured to extract the one or more oils from the spent grain with the scCO₂. The system also includes a separator configured to depressurize the scCO₂ to separate the oil and the scCO₂.

Extraction using scCO₂ is an attractive alternative for corn oil extraction as it is considered a green solvent, produces a higher-quality oil, and has a high extraction efficiency. Traditionally, scCO₂ extraction is not a feasible alternative for corn oil extraction at a dry mill ethanol plant because of the high capital investment required for the compression infrastructure; however, by integrating with an on-site source of CO₂ or scCO₂, such as the CO₂ formed by fermentation of corn, and such as on-site sources including a compressor already in place for CCUS, scCO₂ corn oil extraction is a feasible option. In various aspects, the method and system of the present invention can facilitate scCO₂ extraction of corn oil from a dry mill ethanol plant without significant capital cost or additional energy consumption. In various aspects, a CO₂ source already having a compressor in place for CCUS can drive economic feasibility of integration with scCO₂ extraction.

Various aspects of the present invention integrate supercritical carbon dioxide (scCO₂)-facilitated corn oil extraction in dry mill ethanol plants with existing or planned carbon capture, utilization, and sequestration (CCUS) infrastructure. The utilization of carbon dioxide (CO₂) emissions for extraction can decrease the carbon intensity (CI) of ethanol production and can increase or maximize additional revenue streams to offset the decreasing value and market for ethanol. Additionally, improving or optimizing corn oil production can offer an increased source of localized feedstock for the local petroleum refineries, such as for production of renewable biodiesel. The produced corn oil can provide a green alternative to the primary biodiesel feedstock, as the CI value of corn oil is significantly less than that of soybean oil.

### BRIEF DESCRIPTION OF THE FIGURES

The drawings illustrate generally, by way of example, but not by way of limitation, various aspects of the present invention.

FIG. 1 illustrates a block diagram of corn oil extraction from DDGS using scCO₂ solvent integrated within an ethanol plant, in accordance with various aspects of the present disclosure.

FIG. 2 illustrates a block diagram of corn oil extraction from WS using scCO₂ solvent integrated within an ethanol plant, in accordance with various aspects of the present disclosure.

FIG. 3 illustrates solubility of corn oil in scCO₂ under various conditions, in accordance with various aspects of the present disclosure.

FIG. 4 illustrates a forecasted price of electricity over a 10-year period, in accordance with various aspects of the present disclosure.

FIG. 5 illustrates a forecasted price for coil oil over a 10-year period, in accordance with various aspects of the present disclosure.

FIG. 6 illustrates corn oil recovery efficiency via scCO₂ extraction with respect to pressure and solvent consumption, in accordance with various aspects of the present disclosure.

FIG. 7 illustrates corn oil solubility in scCO₂ between 2900 and 7194 psi and 104° and 176° F., in accordance with various aspects of the present disclosure.

FIG. 8 illustrates the mass of scCO₂ solvent for corn oil extraction in DDGS between 2900 and 7194 psig and 104° and 176° F., in accordance with various aspects of the present disclosure.

FIG. 9 illustrates the mass of scCO₂ solvent for corn oil extraction in WS between 2900 and 7194 psig and 104° and 176° F., in accordance with various aspects of the present disclosure.

FIG. 10 illustrates the mass of oil extracted versus the percentage of oil extracted from DDGS or WS by scCO₂, in accordance with various aspects of the present disclosure.

FIG. 11 illustrates a simulated process for corn oil extraction from DDGS and WS with scCO₂ solvent, in accordance with various aspects of the present disclosure.

FIG. 12 illustrates energy requirements for various scCO₂ extraction and separation conditions for DDGS, in accordance with various aspects of the present disclosure.

FIG. 13 illustrates energy requirements for various scCO₂ extraction and separation conditions for WS, in accordance with various aspects of the present disclosure.

FIG. 14 illustrates estimated annual utility cost for scCO₂-facilitated extraction at various extraction and separation conditions for DDGS. The utility cost is shown at a minimum, median, and maximum price, in accordance with various aspects of the present disclosure.

FIG. 15 illustrates estimated annual utility cost for scCO₂-facilitated extraction at various extraction and separation conditions for WS. The utility cost is shown at a minimum, median, and maximum price, in accordance with various aspects of the present disclosure.

FIG. 16 illustrates estimated annual corn oil product revenues for DDGS and sensitivity analysis for minimum, median, and maximum price for corn oil as well as percentage of corn oil extracted, in accordance with various aspects of the present disclosure.

FIG. 17 illustrates estimated annual corn oil product revenues for WS and sensitivity analysis for minimum, median, and maximum price for corn oil as well as percentage of corn oil extracted, in accordance with various aspects of the present disclosure.

FIG. 18 illustrates estimated minimum, median, and maximum revenue from corn oil minus utility costs at each extraction and separation condition for DDGS, in accordance with various aspects of the present disclosure.

FIG. 19 illustrates estimated minimum, median, and maximum revenue from corn oil minus utility costs at each extraction and separation condition for WS, in accordance with various aspects of the present disclosure.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

### Method of Extracting One or More Oils.

Various aspects of the present invention provide a method of extracting one or more oils from an oil-bearing material using supercritical CO₂ (scCO₂). The oil-bearing material can be any suitable oil-bearing material, such as a plant product (e.g., fermented or un-fermented grains, oilseeds, agricultural products), algae, a waste product (e.g., drill cuttings, municipal solid waste), an animal product, or a combination thereof. The method can include compressing CO₂ to form supercritical CO₂ (scCO₂), and/or collecting scCO₂. The method can also include extracting one or more oils from the oil-bearing material using the formed and/or collected scCO₂.

The method can include compressing CO₂ gas produced or available on-site (e.g., within five miles of the extraction) to form scCO₂, and/or collecting scCO₂ produced or available on-site. Alternatively, the method can include compressing CO₂ gas produced or available off-site (e.g., more than five miles from the extraction, such as more than 10 miles, 100 miles, or 1,000 miles) to form scCO₂, and/or collecting scCO₂ produced or available off-site.

The CO₂ gas produced or available on-site or off-site can be formed from any suitable on-site process, such as chemical manufacture, fuel manufacture, pharmaceutical manufacture, agribusiness, food or beverage manufacture, electricity generation, fermentation of a grain to form the fermented grain, or a combination thereof.

In various aspects, the CO₂ gas can include gas produced by fermentation of a grain to form a spent grain. The method of extracting one or more oils can include compressing CO₂ gas produced by fermentation of the grain, to form scCO₂, wherein the fermentation of the grain forms the spent grain. The method can include extracting the one or more oils from the spent grain with the scCO₂. The method can also include separating the oil and the scCO₂.

In various aspects, the CO₂ gas can include gas produced by a boiler used in the fermentation of the grain. For example, the CO₂ gas can include an exhaust gas produced by combustion of natural gas or another fuel source to heat the boiler. The method of extracting one or more oils can include compressing CO₂ gas produced by a boiler used in the fermentation of the grain, to form scCO₂, wherein the fermentation of the grain forms a spent grain. The method includes extracting the one or more oils from the spent grain with the scCO₂. The method can also include separating the oil and the scCO₂.

The grain from which the oil is extracted can be any suitable one or more grains. The grain can include wheat, sorghum, barley, rye, cassava, rice, triticale, corn, or a combination thereof. The grain can include corn. The grain can be in any suitable physical form during the fermentation of the grain and/or the extraction of the grain, such as in a ground and/or pulverized form. The fermentation of the grain can produce ethanol.

The spent grain from which the one or more oils are extracted by scCO₂ is formed by the fermentation of the grain, and is optionally formed via steps further including distilling ethanol from the grain, removal of a portion of oil in the grain (e.g., centrifuging the grain after fermentation and ethanol removal), drying the grain, evaporation from the grain, or a combination thereof. The spent grain can be spent grain that is taken from any suitable location in the fermentation process for the grain. For example, the spent grain can include dried distillers grains with solubles (DDGS), whole stillage (WS), grain from downstream of a hammer mill, a liquefaction tank, a fermenter, a centrifuge, or a dryer, or a combination thereof. The spent grain can include dried distillers grains with solubles (DDGS). The spent grain can include whole stillage (WS).

The fermentation of the grain and the extraction of the spent grain with the scCO₂ can be performed at the same site, such as within 5 miles of one another, or less than or equal to 5 miles and greater than or equal to 0 miles and less than, equal to, or greater than 0.1 miles, 0.2, 0.3, 0.4, 0.5, 0.6, 0.7, 0.8, 0.9, 1, 1.2, 1.4, 1.6, 1.8, 2, 2.5, 3, 3.5, 4, or 4.5 miles. In other aspects, the fermentation of the grain and the extraction of the spent grain with the scCO₂ can be performed at different sites, such as more than 5 miles from one another.

In various aspects, fermentation of the grain to produce the CO₂ is performed prior to the onset of the method. In other aspects, the method of the present invention includes performing the fermentation of the grain.

The method can include compressing CO₂ (e.g., gas or liquid) produced or available on-site (e.g., within five miles of the extraction) to form scCO₂. The method can include compressing CO₂ gas produced from fermentation of a grain to form the spent grain. The compressing can be performed by a compressor, such as any suitable compressor. The method can further include heating or cooling the CO₂ using a heater or cooler prior to and/or after compression to adjust the temperature thereof prior to the extract. The method can include compressing the CO₂ to a pressure of 1000 psig (6.9 MPa) or above, or 2900 psig (20 MPa) to 7200 psig (49.6 MPa), or 2900 psig (20 MPa) to 5100 psig (35.2 MPa), or less than or equal to 7200 psig (49.6 MPa) and greater than or equal to 2900 psig (20 MPa) and less than, equal to, or greater than 21 MPa, 22, 23, 24, 25, 26, 27, 28, 29, 30, 31, 32, 33, 34, 35, 36, 38, 40, 42, 44, 46, or 48 MPa, wherein the pressure is measured downstream of the compressor, downstream of any heater or cooler, or a combination thereof. The scCO₂ formed in the compressor, or the scCO₂ downstream of the heater or cooler, can have any suitable temperature, such as a temperature of 80° F. (26.7° C.) or above, or 100° F. (37.8° C.) to 180° F. (82.2° C.), or 100° F. (37.8° C.) to 150° F. (65.6° C.), or less than or equal to 180° F. (82.2° C.) and greater than or equal to 100° F. (37.8° C.) and less than, equal to, or greater than 38° C., 40, 42, 44, 46, 48, 50, 52, 54, 56, 58, 60, 62, 64, 66, 68, 70, 72, 74, 76, 78, or 80° C.

The extracting of the one or more oils from the spent grain can include placing the spent grain and the scCO₂ in intimate contact in an extractor. The extraction can be performed at a pressure of 1000 psig (6.9 MPa) or above, 2900 psig (20 MPa) to 7200 psig (49.6 MPa), or 2900 psig (20 MPa) to 5100 psig (35.2 MPa), or less than or equal to 7200 psig (49.6 MPa) and greater than or equal to 2900 psig (20 MPa) and less than, equal to, or greater than 21 MPa, 22, 23, 24, 25, 26, 27, 28, 29, 30, 31, 32, 33, 34, 35, 36, 38, 40, 42, 44, 46, or 48 MPa. The extraction can be performed at a temperature of 80° F. (26.7° C.) or above, or 100° F. (37.8° C.) to 180° F. (82.2° C.), or 100° F. (37.8° C.) to 150° F. (65.6° C.), or less than or equal to 180° F. (82.2° C.) and greater than or equal to 100° F. (37.8° C.) and less than, equal to, or greater than 38° C., 40, 42, 44, 46, 48, 50, 52, 54, 56, 58, 60, 62, 64, 66, 68, 70, 72, 74, 76, 78, or 80° C. The scCO₂ used for the extracting can optionally include scCO₂ that is recycled from the extracting.

The method can also include separating the oil and the scCO₂, to form a separated oil and used CO₂. The separating can include depressurizing the scCO₂, which can significantly reduce the solubility of the one or more oils in the scCO₂, causing the one or more oils to separate from the scCO₂. The separation can be performed in any suitable equipment, such as a separator including an outlet stream including the one or more oils and another outlet stream including the scCO₂. The separating can be performed at any suitable pressure, such as a pressure of 1000 psig (6.9 MPa) to 1500 psig (10.3 MPa), or less than or equal to 1500 psig (10.3 MPa) and greater than or equal to 1000 psig (6.9 MPa) and less than, equal to, or greater than 7 MPa, 7.2, 7.4, 7.6, 7.8, 8, 8.2, 8.4, 8.6, 8.8, 9, 9.2, 9.4, 9.6, 9.8, 10, or 10.2 MPa. The separating can be performed at any suitable temperature, such as a temperature of 80° F. (26.7° C.) to 200° F. (93.3° C.), 100° F. (37.8° C.) to 160° F. (71.1° C.), or less than or equal to 200° F. (93.3° C.) and greater than or equal to 80° F. (26.7° C.) and less than, equal to, or greater than 28° C., 30, 32, 34, 36, 38, 40, 42, 44, 46, 48, 50, 52, 54, 56, 58, 60, 62, 64, 66, 68, 70, 72, 74, 76, 78, 80, 82, 84, 86, 88, 90, or 92° C.

The method can include sequestering the used CO₂, storing the used CO₂, recycling the used CO₂ for reuse in the method, or a combination thereof. The method can include recycling the used CO₂ stream for reuse in the method as a portion of the scCO₂ used for the extracting one or more oils from the spent grain. During the extracting the mass ratio of the scCO₂ formed via the compressing to the recycled scCO₂ can be 100:1 to 1:100, or 10:1 to 1:10, or less than or equal to 100:1 and greater than or equal to 1:100 and less than, equal to, or greater than 1:90, 1:80, 1:70, 1:60, 1:50, 1:40, 1:30, 1:20, 1:10, 1:8, 1:6, 1:5, 1:4, 1:3, 1:2, 1:1, 2:1, 3:1, 4:1, 5:1, 6:1, 8:1, 10:1, 20:1, 30:1, 40:1, 50:1, 60:1, 70:1, 80:1, or 90:1. The recycling can include re-compressing the CO₂ to form scCO₂.

### System for Extracting One or More Oils.

Various aspects of the present invention provide a system for performing the method of extracting one or more oils described herein. The system for extracting one or more oils can include a compressor that is configured to compress CO₂ to form scCO₂. The CO₂ is produced or available on-site (e.g., within five miles of the extraction). The CO₂ can be formed via fermentation of a grain to form the CO₂ and a spent grain. The system includes an extractor configured to extract the one or more oils from the spent grain with the scCO₂. The system also includes a separator that is configured to depressurize the scCO₂ to separate the oil and the scCO₂.

### EXAMPLES

Various aspects of the present invention can be better understood by reference to the following Examples which are offered by way of illustration. The present invention is not limited to the Examples given herein.

### Example 1. Integration of scCO₂-Facilitated Extraction with CCUS: Introduction, Background, and General Methodology

### Introduction.

Corn oil is collected as a by-product of ethanol production at dry mill plants both in North Dakota and across the United States. Increasing the extraction efficiency of corn oil can generate additional revenue to offset the decreasing value and market for ethanol. Increased production of corn oil can have application to further processing at local refineries, such as for production of renewable biodiesel or sustainable aviation fuel (SAF). Corn oil is an attractive option for renewable biodiesel and SAF as the carbon intensity (CI) is significantly less than that of soybean oil.

One method for optimization of oil extraction proven successful at a smaller scale is supercritical carbon dioxide (scCO₂)-facilitated solvent extraction. scCO₂ extraction is an attractive alternative for corn oil extraction as it is considered a green solvent, produces a higher-quality oil, and has a high extraction efficiency. scCO₂ corn oil extraction from various dry mill ethanol plant process streams has proven to be effective, although it has no path to commercialization because of the economic constraints of the capital investment.

Interest is growing for carbon capture, utilization, and sequestration (CCUS) at a dry mill ethanol plant to capture the high-purity carbon dioxide (CO₂) produced from the fermentation process, compressed for transportation to an appropriate storage location and, ultimately, sequestered. CCUS deployment at ethanol plants can create a synergy of CCUS and scCO₂-facilitated extraction. The capital investment for compression and storage for CCUS at North Dakota ethanol plants could offset the high capital cost of compression to generate scCO₂, creating an economically feasible pathway for scCO₂-facilitated extraction at the industrial scale. The integration of CCUS and scCO₂-facilitated oil extraction can include additional compression to condition the CO₂ from fermentation to extraction conditions—routed through the scCO₂ extraction technology, decrease the pressure of the extract stream to collect the corn oil as the product, and recycle the CO₂ back to the appropriate compressor stage to be recompressed and ultimately sequestered.

### Background.

Each of five North Dakota ethanol plants processes between 23 and 60 million bushels (bu) of corn per year, contributing to the cumulative 105-180 million bu of corn processed in North Dakota annually (North Dakota Ethanol Council, 2016). On average, a typical ethanol plant generates 18 pounds (lb) of CO₂ emissions per bushel of corn during fermentation and extracts up to 1 lb of corn oil per bushel of corn following distillation. The production rates of the North Dakota ethanol facilities are shown in Table 1.

TABLE 1
Comparison of Annual Throughputs and Production at North
Dakota Ethanol Plants.

| Ethanol Facility | Corn, bu | Corn Oil, lb | CO₂, lb |
|---|---|---|---|
| Blue Flint | 25,000,000 | 20,000,000 | 450,000,000 |
| Dakota Spirit | 25,000,000 | 20,000,000 | 450,000,000 |
| Red Trail Energy | 23,000,000 | 18,000,000 | 410,000,000 |
| Hankinson Renewable | 52,000,000 | 42,000,000 | 940,000,000 |
| Energy | | | |
| Tharaldson Ethanol | 60,000,000 | 48,000,000 | 1,100,000,000 |

The majority of ethanol plants use a dry mill process instead of a wet mill process because of lower operating costs. The corn feedstock undergoes five major process steps: grinding, cooking and liquefaction, saccharification, fermentation, and distillation. Presently, the available technology for corn oil extraction is primarily centrifugation following distillation for ethanol collection. The annual corn oil extraction for each North Dakota ethanol plant (Table 1) represents approximately 50% of the oil present in the processed corn feedstock with the remaining oil contained in the distillers grain, sold as a by-product for animal feed. Corn oil extraction could be implemented for many process streams within a dry mill ethanol process; however, the most promising process streams are whole stillage (WS) or wet distillers grain. These two process streams present the best opportunity for extraction, as the oil concentration is higher compared to other potential locations. Other potential process locations include following the hammer mills, liquefaction tank, fermenter, centrifugation, and dryers.

### Integration: General Methodology.

An opportunity exists for a variety of industries to integrate scCO₂-facilitated extraction of with existing CCUS infrastructure and increase by-product revenue streams. The integration could occur at a variety of facilities, industries, and locations with access to scCO₂ either directly from a process stream intended for CCUS or a pipeline transporting scCO₂ intended for sequestration. This may include facilities and industries with potential to be paired with a CCUS facility. Examples of the potential markets for this invention may include wet and dry mill ethanol plants or power generation from any initial feedstock source. Industries with on-site CO₂ production include examples such as chemicals and fuels, pharmaceuticals, or agribusiness. The potential for integration exists at North Dakota ethanol facilities to utilize CO₂ emissions from fermentation by implementing scCO₂-facilitated extraction for corn oil extraction.

To date, the inhibiting factor of implementation of scCO₂ extraction is the lack of economic feasibility; however, by pairing the process with existing CCUS infrastructure, scCO₂-facilitated extraction may be economically feasible. The high-cost capital investment for compression of CO₂ from atmospheric conditions to a supercritical state is in progress for many facilities spanning a wide variety of industries; hence, an opportunity exists to integrate an extraction system to utilize CO₂ before sequestration. Integration of an extraction process would require additional compression beyond the specified value for CO₂ sequestration; however, the initial compression stage requires the higher capital cost and energy input. Because the capital cost for the initial compression stage is part of the scope of a CCUS facility, the small capital cost required for the addition of a scCO₂ extraction facility may be economically feasible.

Further utilization of CO₂ produced from fermentation could reduce the overall CI of the associated facility because of additional corn oil product recovery and utilization of CO₂. The carbon intensity (CI) value would be reduced on a per unit product basis as additional product is generated. Next, the CI value would be reduced because of the use of a more environmentally friendly solvent to replace other solvents for extraction facilities. Finally, the CI value would be decreased because the utilization of CO₂ would be increased. The reduction of CI on a per unit basis results in a higher-value product, which incentivizes implementation.

The scCO₂ stream intended for CCUS would first be routed either directly from the existing compression system or from a transportation pipeline to an extraction unit to dissolve the desired product in the scCO₂ before entering a separation unit. The separation unit would decrease the pressure of the CO₂/product stream to separate the CO₂ from the desired product. The product would be collected and the CO₂ recycled to an appropriate place in the process, either into the compression train or the pipeline before ultimately being sequestered. Additionally, a by-product would be produced as part of the extraction. The quantity of the product and by-product is dependent on the extraction efficiency achieved during the process. For a dry mill ethanol plant, the main product will be corn oil which could be salable as a precursor for biodiesel or sustainable aviation fuel. The by-product produced would be a defatted distillers grain salable as a high-protein animal feed.

Implementation for each facility will require slightly different optimized operating parameters. For implementation at a traditional North Dakota dry mill corn ethanol plant, the likely range of pressures and temperatures for extraction is between 2900 and 5100 psig and 100° and 150° F., respectively, but the range of operating conditions may include pressures up to 7200 psig and temperatures up to 180° F. The likely range of pressures and temperatures for separation is between 1000 and 1500 psig and 100° and 160° F., respectively. The corn oil would be collected, while the depressurized CO₂ stream would be repressurized and conditioned before being recycled to the appropriate stage in the CCUS train. A polishing unit for the CO₂ may be required for the gas stream to accomplish the necessary specifications for gas recycle.

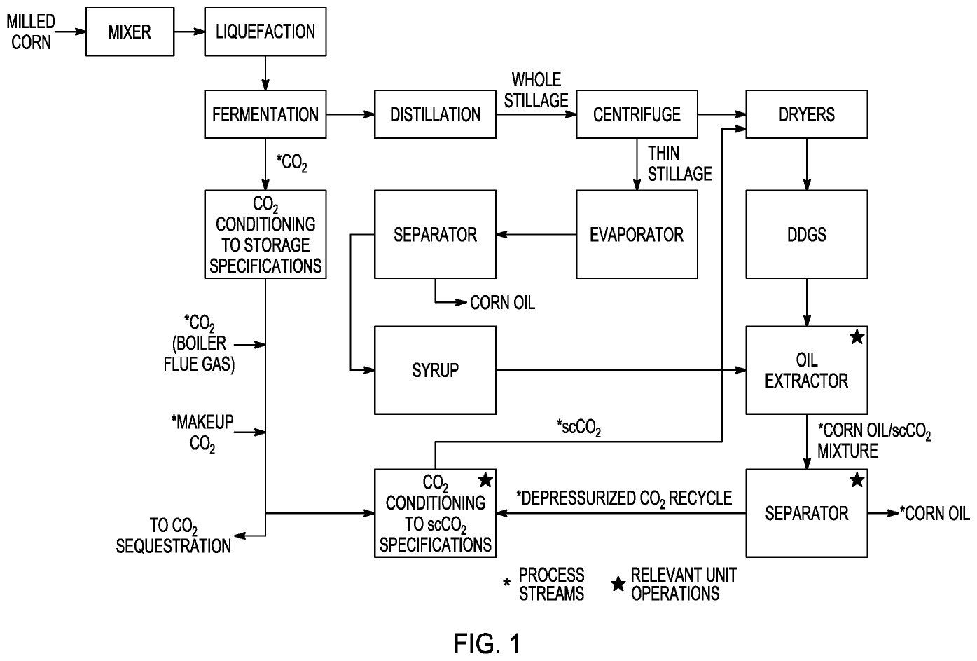

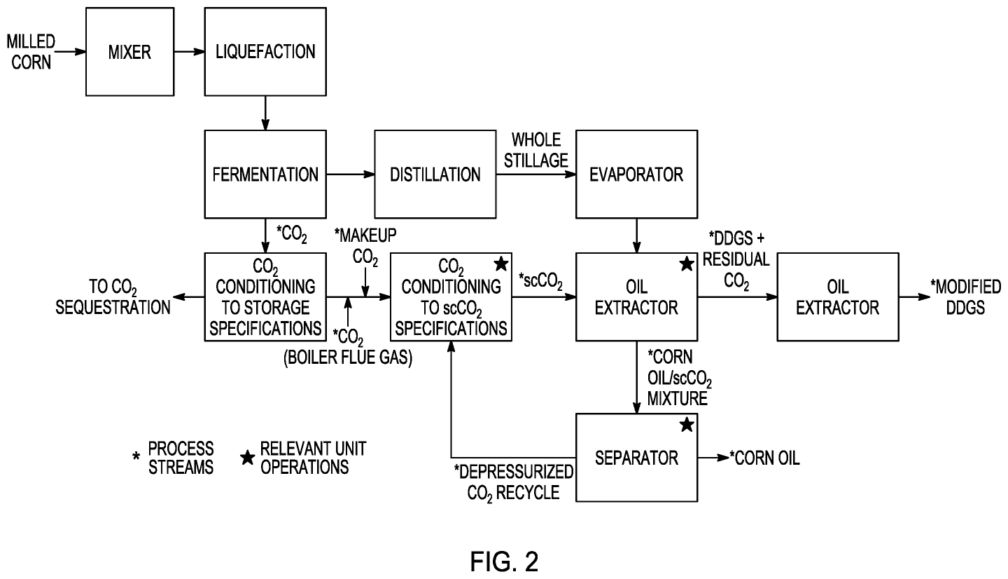

This study proposes integration with existing ethanol operations, which include carbon capture and processing for CCUS. The integration is dependent on the oil extraction location, with the primary focus for this study being two extraction points within ethanol production, dried distillers grains with solubles (DDGS) and WS. Both extraction scenarios are incorporated within dry mill ethanol production and would involve the same process steps up until post-distillation. In the DDGS extraction case, shown in FIG. 1, the extraction process is an addition to the current ethanol production process and defats the DDGS product before it is sent to storage. Comparatively, the WS extraction case, shown in FIG. 2, eliminates several unit operations that are currently used to extract oil, which involves the production of thin stillage. The integration of WS extraction would require moisture evaporation of WS prior to extraction followed by defatted DDGS product processing. The solvent used for both extraction scenarios is the CO₂ produced from fermentation and emissions from on-site power generation, which is pressurized beyond CCUS requirements to supercritical conditions. scCO₂ extracts 0.8 lb/bu from DDGS and 1.6 lb/bu from WS (North Dakota Ethanol Council, 2016). The solute is collected upon depressurization, and the solvent is recycled. Any excess CO₂ from production is routed to storage or pipeline for alternative utilization opportunities.

### Example 2. Integration of scCO₂-Facilitated Extraction with CCUS: Simulation and Analysis

### Process Specifications.

In this study, CO₂ emissions from an ethanol facility were employed as a solvent to extract corn oil from DDGS and WS. The scope of work focused on the utilization of CO₂ at the site of emission origin, which excludes any equipment and energy associated with CCS. The boundaries were defined to perform a preliminary economic feasibility study of scCO₂-facilitated extraction featuring the most energy-intensive operations. The simulation and subsequent analysis are confined to the process of corn oil extraction, solute and solvent separation, and scCO₂ recycle.

The model basis for corn oil extraction using scCO₂ was developed using mass balance values from an existing ethanol facility and solubility data available in scientific literature for corn oil in scCO₂. The number of bushels processed per year at an ethanol facility is the foundation for the baseline conditions in the study. The conditions pertinent to the model are the amount of oil extracted from DDGS and WS as well as the CO₂ produced within the ethanol facility from fermentation and flue gas emissions. A summary of baseline conditions can be found in Table 2.

TABLE 2
Baseline Conditions for Corn Oil Extraction from DDGS
and WS with scCO₂ Within an Ethanol Facility.

| Baseline Condition | Unit/year |
|---|---|
| Ethanol Production Rate, bu | 25,000,000 |
| Oil Extracted from DDGS, lb | 20,000,000 |
| Oil Extracted from WS, lb | 40,000,000 |
| CO₂ Production from Fermentation, lb | 510,000,000 |
| CO₂ Production from Flue Gas, lb | 310,000,000 |

The emissions of CO₂ from ethanol production are captured in the fermentation process and boiler flue gas emissions from on-site power generation. After the CO₂ is captured, the gas undergoes purification to remove contaminants, as well as pressurization and cooling to geologic sequestration conditions at 1525 psi and 85° F. The sequestration conditions are specific to this study but are subject to change on a case-by-case basis.

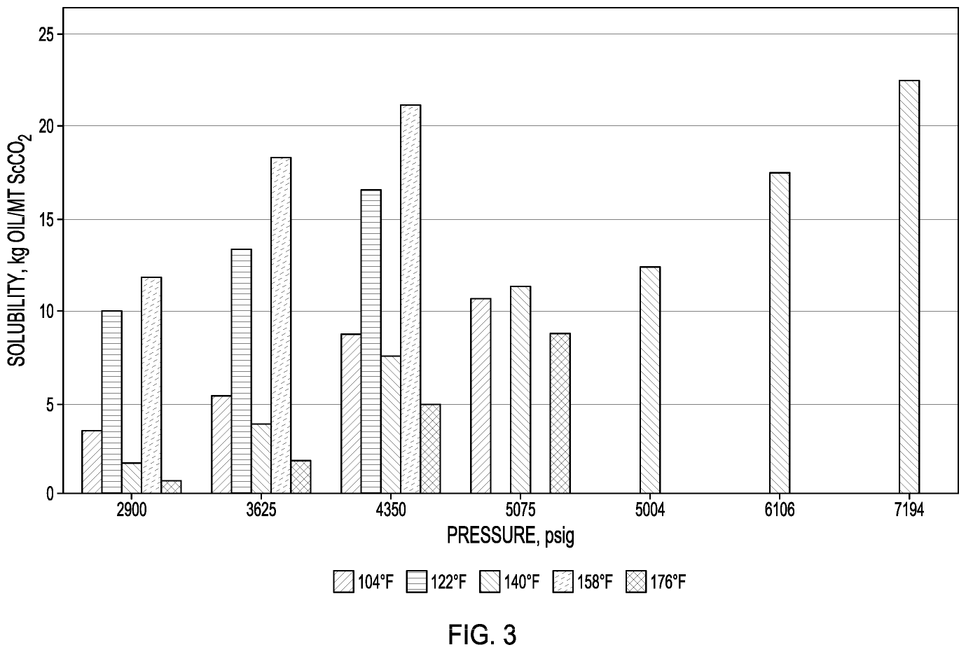

The purified CO₂ is pressurized and heated or cooled from injection well conditions to supercritical conditions, which ranged from 2900 to 7194 psi and 104° to 176° F., congruent with corn oil solubility in scCO₂ literature data. The solubility conditions used in the study are summarized in FIG. 3.

The scCO₂ is then sent to an extractor vessel, which removes 0.8 lb of oil per bushel in DDGS and 1.6 lb of oil per bushel in WS. On a basis of 25 million bu per year, the oil extracted is 20 million lb from DDGS and 40 million lb from WS when 100% of the oil fraction is extracted. The solvent losses during extraction were analyzed at 15%, 10%, and 5% of the recycle stream, but successive calculations assumed 5% solvent loss.

The solubility at the specific extraction condition and the amount of oil extracted determined the required mass of scCO₂. Additional CO₂ was combined with the recycle stream to account for solvent losses during the extraction operation. The excess CO₂ is the difference between the scCO₂ required for extraction and the CO₂ losses and is routed to the injection wellhead for geological sequestration or to a pipeline for alternative utilization opportunities.

The ratio of CO₂ required for extraction to CO₂ produced was used in mass balance calculations to reduce the scale of values and is shown in Table 3 for DDGS and Table 4 for WS. All flow ratio values exceeded one except for the condition at 7194 psig and 158° F. for DDGS, which indicates that to facilitate extraction, additional CO₂ will be required before steady-state conditions are achieved.

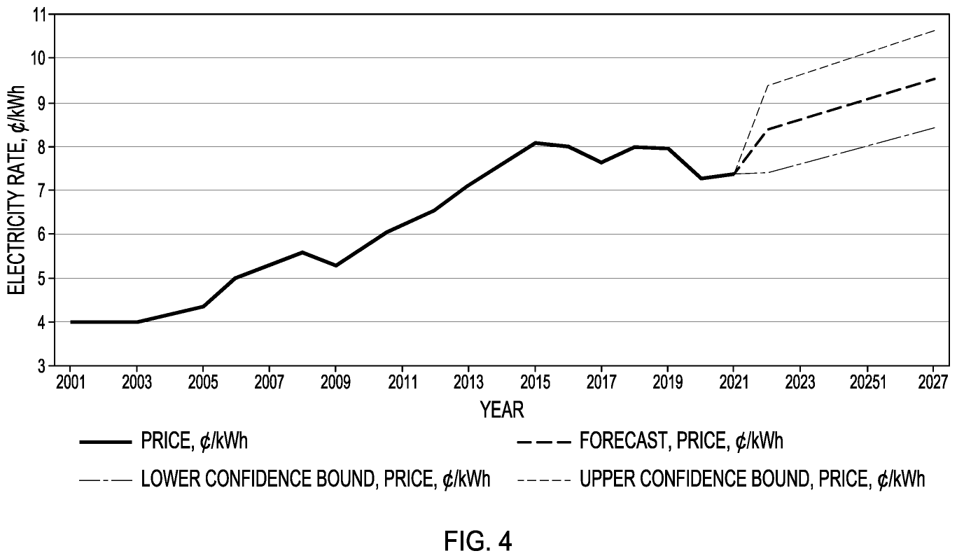

The industrial price for electricity in North Dakota was forecasted for 10 years with historical data from 2001 to 2021 and is shown in FIG. 4. The maximum, median, and minimum of the forecasted values were used in economic calculations to simulate the volatility of the investment. The most energy-intensive condition showed a percent difference increase of 358% from the median electricity price and as much as a 129% decrease at the minimum value.

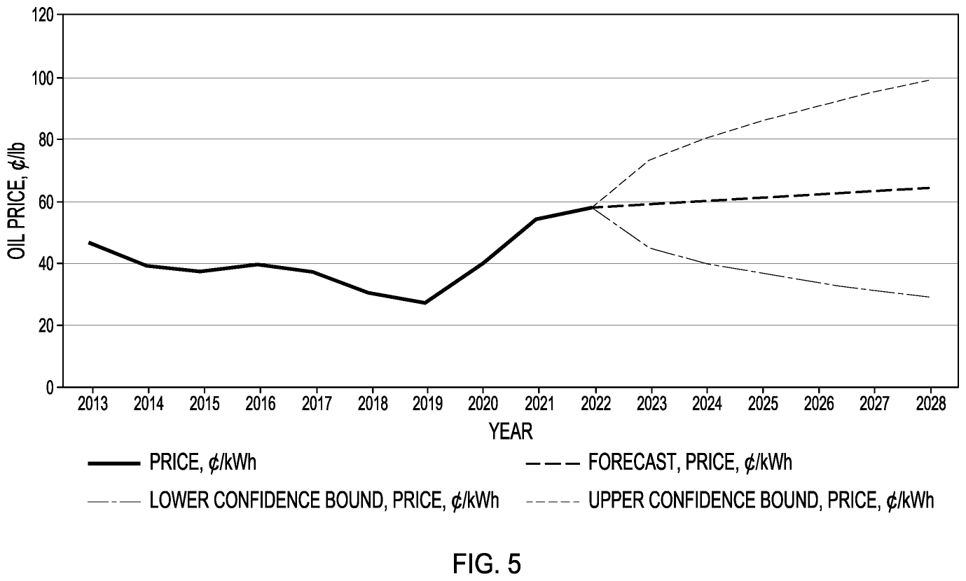

The price of corn oil was also determined using forecasted values from historical data from 2013 to 2021, as shown in FIG. 5. The 10-year forecasted price was represented by the minimum, median, and maximum values in the economic calculations. The price is less volatile than the electricity cost and appears to trend upward.

TABLE 3
scCO₂ Flow Ratios Used for Mass Balance
Calculations at DDGS Extraction Point.

| Conditions | | scCO₂ Required: CO₂ Production | |
|---|---|---|---|
| Pressure, | Temperature, | | Fermentation |
| psig | ° F. | Fermentation | and Flue Gas |
| 2900 | 104 | 11.13 | 6.97 |
| | 140 | 22.92 | 14.34 |
| | 176 | 55.66 | 34.84 |
| 3625 | 104 | 7.21 | 4.52 |
| | 140 | 9.99 | 6.25 |
| | 176 | 20.50 | 12.83 |
| 4350 | 104 | 4.48 | 2.80 |
| | 140 | 5.19 | 3.25 |
| | 176 | 7.79 | 4.88 |
| 5004 | 122 | 3.90 | 2.44 |
| | 140 | 3.12 | 1.95 |
| | 158 | 3.25 | 2.03 |
| 5075 | 104 | 3.64 | 2.28 |
| | 140 | 3.42 | 2.14 |
| | 176 | 4.43 | 2.77 |
| 6106 | 122 | 2.89 | 1.81 |
| | 140 | 2.23 | 1.39 |
| | 158 | 2.13 | 1.33 |
| 7194 | 122 | 2.36 | 1.48 |
| | 140 | 1.73 | 1.08 |
| | 158 | 1.50 | 0.94 |

TABLE 4
scCO₂ Flow Ratios Used for Mass Balance
Calculations at WS Extraction Point.

| Conditions | | scCO₂ Required: CO₂ Production | |
|---|---|---|---|
| Pressure, | Temperature, | | Fermentation |
| psig | ° F. | Fermentation | and Flue Gas |
| 2900 | 104 | 22.26 | 13.93 |
| | 140 | 45.83 | 28.69 |
| | 176 | 111.31 | 69.67 |
| 3625 | 104 | 14.43 | 9.03 |
| | 140 | 19.98 | 12.51 |
| | 176 | 41.01 | 25.67 |
| 4350 | 104 | 8.96 | 5.61 |
| | 140 | 10.39 | 6.50 |
| | 176 | 15.58 | 9.75 |
| 5004 | 122 | 7.79 | 4.88 |
| | 140 | 6.23 | 3.90 |
| | 158 | 6.49 | 4.06 |
| 5075 | 104 | 7.28 | 4.56 |
| | 140 | 6.83 | 4.28 |
| | 176 | 8.85 | 5.54 |
| 6106 | 122 | 5.77 | 3.61 |
| | 140 | 4.45 | 2.79 |
| | 158 | 4.26 | 2.67 |
| 7194 | 122 | 4.72 | 2.96 |
| | 140 | 3.46 | 2.17 |
| | 158 | 3.00 | 1.88 |

The process stream is conditioned for the separation vessel by reducing the pressure between 1088 and 1450 psi and the temperature between 104° and 158° F. to separate the corn oil and solvent. The density of the scCO₂ decreases within the temperature and pressure ranges, which reduces the solubility of corn oil, thereby causing the oil and scCO₂ to phase-separate. The operating conditions were designed to separate the entire oil fraction, but fractionization of the phosphatide, triglyceride, and free fatty acid fraction may be accomplished by stepwise pressure reduction. The study assumed 100% separation of solute and solvent at the three conditions shown in Table 5.

TABLE 5
Separation Pressure and Temperature Conditions for Corn Oil and
scCO₂ Between 1088 and 1450 psig and 104° and 158° F.

| | Pressure, | Temperature, |
|---|---|---|
| Separation Condition Description | psig | ° F. |
| High Temperature and Low Pressure | 1088 | 158 |
| (HTLP) | | |
| Medium Temperature and Medium | 1269 | 131 |
| Pressure (MTMP) | | |
| Low Temperature and High Pressure | 1450 | 104 |
| (LTHP) | | |

The depressurized CO₂ from the separator vessel is cooled to a liquid and then pressurized by pump to injection well conditions. The recycled liquid CO₂ is then mixed with the processed CO₂ from fermentation and flue gas to make up for solvent losses.

### Simulation Assumptions.

The scope of work involved screening multiple process conditions at a lower granularity. This level of design requires assumptions that may be revaluated during future iterations of the study. To limit the scope of the study, the equipment for CO₂ pressurization to injection well conditions was assumed to be installed and implemented at the ethanol facility. Any makeup CO₂ required was assumed to be available at the same conditions at which the on-site-generated CO₂ was processed, 85° F. and 1510 psig.

The simulation involved several unit operations for scCO₂ processing, corn oil extraction, and scCO₂ and oil separation. The scCO₂ processing before extraction and after separation required heat exchangers and pumps. All heat exchangers were assumed to have a pressure drop of 2 psi at each condition. The pumps were assumed to operate at 75% adiabatic efficiency. These assumptions were made because of the wide range of conditions analyzed in this study.

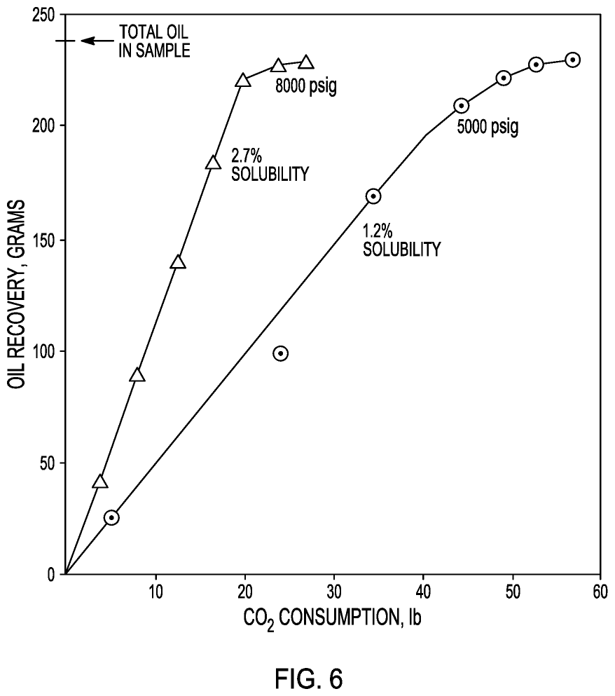

The corn oil extraction following scCO₂ processing assumed 100% extraction efficiency from DDGS and WS and no interaction between water fraction in WS and CO₂. The efficiency of oil extraction is a factor of corn oil solubility in scCO₂ and increases linearly as more solvent is utilized, as shown in FIG. 6 (the conditions used were a supercritical extraction of 8% tempered and flaked dry-milled corn (1,000 g) in a cylindrical vessel (2 L, 2 7/16 in. i.d.×29¼ in. long) at a CO₂ flow rate of 15-18 L/min and a temperature of 50° C.). The linear relationship represents easily accessible oil and approaches the theoretical oil content. The graph then begins to curve as the extraction asymptotically approaches the theoretical maximum, where the corn oil experiences mass transport limitations.

During extraction, mass balance calculations assumed 5% solvent losses, which is consistent with Apeks supercritical oil-extracting equipment specifications for extraction from biomass at 5000 psig but at smaller flow rates, which range from 140 to 200 lb/day. Alternative sources claim less than 1% loss during extraction at low-solubility conditions and 14% scCO₂ losses with increasing solubility. At steady-state operation, the greater the solvent losses during extraction results in additional makeup CO₂ and less sequestered CO₂.

After extraction, scCO₂ and corn oil separation was assumed to be a complete separation between solute and solvent. The assumed 100% separation was founded on the logic of the high-quality and residue-free oil produced from the scCO₂ extraction method. The assumption was further strengthened by separation conditions for scCO₂ and corn oil reported between 104° and 158° F. and 1088 and 1450 psig.

The list of conditions varied in the model is shown in Tables 6A-6B. The values in each row represent one solubility condition that is dependent on the temperature and pressure of the corn oil extraction with supercritical carbon dioxide (scCO₂) for dried distillers grains with solubles (DDGS) and whole stillage (WS). The solubility is proportional to pressure; therefore, the solubility increases as pressure increases, while temperature does not have a linear relationship with solubility. An increase in solubility decreases the scCO₂ solvent required for extraction, which is represented by the DDGS and WS CO₂ extraction-to-production ratios.

After extraction, the scCO₂ and oil mixture is cooled and depressurized until the solubility is essentially zero, which promotes separation between the two components. The separation conditions were varied within 104° to 158° F. and 1088 to 1450 psi and were represented as high temperature and low pressure (HTLP), medium temperature and medium pressure (MTMP), or low temperature and high pressure (LTHP). The energy requirements for separation were most favorable for LTHP conditions, which required the least amount of repressurization while recycling the scCO₂.

TABLE 6A
Comprehensive List of Conditions Varied in the Process
Described in the Process Specifications Section.

| | | | | DDGS CO₂ | WS CO₂ | |
|---|---|---|---|---|---|---|
| | Pressure, | | Solubility, | Extraction-to- | Extraction-to- | Separation |
| Condition | psig | Temperature, ° F. | kg kg − 1 | Production Ratio | Production Ratio | Conditions |
| A1 | 2900 | 104 | 0.0035 | 11.1 | 22.3 | HTLP |
| A2 | | | | | | MTMP |
| A3 | | | | | | LTHP |
| B1 | 2900 | 140 | 0.0017 | 22.9 | 45.8 | HTLP |
| B2 | | | | | | MTMP |
| B3 | | | | | | LTHP |
| C1 | 2900 | 176 | 0.0007 | 55.7 | 111 | HTLP |
| C2 | | | | | | MTMP |
| C3 | | | | | | LTHP |
| D1 | 3625 | 104 | 0.0054 | 7.21 | 14.4 | HTLP |
| D2 | | | | | | MTMP |
| D3 | | | | | | LTHP |
| E1 | 3625 | 140 | 0.0039 | 9.99 | 20.0 | HTLP |
| E2 | | | | | | MTMP |
| E3 | | | | | | LTHP |
| F1 | 3625 | 176 | 0.0019 | 20.5 | 41.01 | HTLP |
| F2 | | | | | | MTMP |
| F3 | | | | | | LTHP |
| G1 | 4350 | 104 | 0.0087 | 4.48 | 8.96 | HTLP |
| G2 | | | | | | MTMP |
| G3 | | | | | | LTHP |
| H1 | 4350 | 140 | 0.0075 | 5.19 | 10.4 | HTLP |
| H2 | | | | | | MTMP |
| H3 | | | | | | LTHP |
| I1 | 4350 | 176 | 0.005 | 7.79 | 15.6 | HTLP |
| I2 | | | | | | MTMP |
| I3 | | | | | | LTHP |
| J1 | 5004 | 122 | 0.01 | 3.90 | 7.79 | HTLP |
| J2 | | | | | | MTMP |
| J3 | | | | | | LTHP |

TABLE 6B
Comprehensive List of Conditions Varied in the Process Described in the Process Specifications Section.

| | | | | | WS CO₂ | |
|---|---|---|---|---|---|---|
| | Pressure, | | Solubility, | DDGS CO₂ Extraction-to- | Extraction-to- | Separation |
| Condition | psig | Temperature, ° F. | kg kg − 1 | Production Ratio | Production Ratio | Conditions |
| K1 | 5004 | 140 | 0.0125 | 3.12 | 6.23 | HTLP |
| K2 | | | | | | MTMP |
| K3 | | | | | | LTHP |
| L1 | 5004 | 158 | 0.012 | 3.25 | 6.49 | HTLP |
| L2 | | | | | | MTMP |
| L3 | | | | | | LTHP |
| M1 | 5075 | 104 | 0.0107 | 3.64 | 7.28 | HTLP |
| M2 | | | | | | MTMP |
| M3 | | | | | | LTHP |
| N1 | 5075 | 140 | 0.0114 | 3.42 | 6.83 | HTLP |
| N2 | | | | | | MTMP |
| N3 | | | | | | LTHP |
| O1 | 5075 | 176 | 0.0088 | 4.43 | 8.85 | HTLP |
| O2 | | | | | | MTMP |
| O3 | | | | | | LTHP |
| P1 | 6106 | 122 | 0.0135 | 2.89 | 5.77 | HTLP |
| P2 | | | | | | MTMP |
| P3 | | | | | | LTHP |
| Q1 | 6106 | 140 | 0.0175 | 2.23 | 4.45 | HTLP |
| Q2 | | | | | | MTMP |
| Q3 | | | | | | LTHP |
| R1 | 6106 | 158 | 0.0183 | 2.13 | 4.26 | HTLP |
| R2 | | | | | | MTMP |
| R3 | | | | | | LTHP |
| S1 | 7194 | 122 | 0.0165 | 2.36 | 4.72 | HTLP |
| S2 | | | | | | MTMP |
| S3 | | | | | | LTHP |
| T1 | 7194 | 140 | 0.0225 | 1.73 | 3.46 | HTLP |
| T2 | | | | | | MTMP |
| T3 | | | | | | LTHP |
| U1 | 7194 | 158 | 0.026 | 1.50 | 3.00 | HTLP |
| U2 | | | | | | MTMP |
| U3 | | | | | | LTHP |

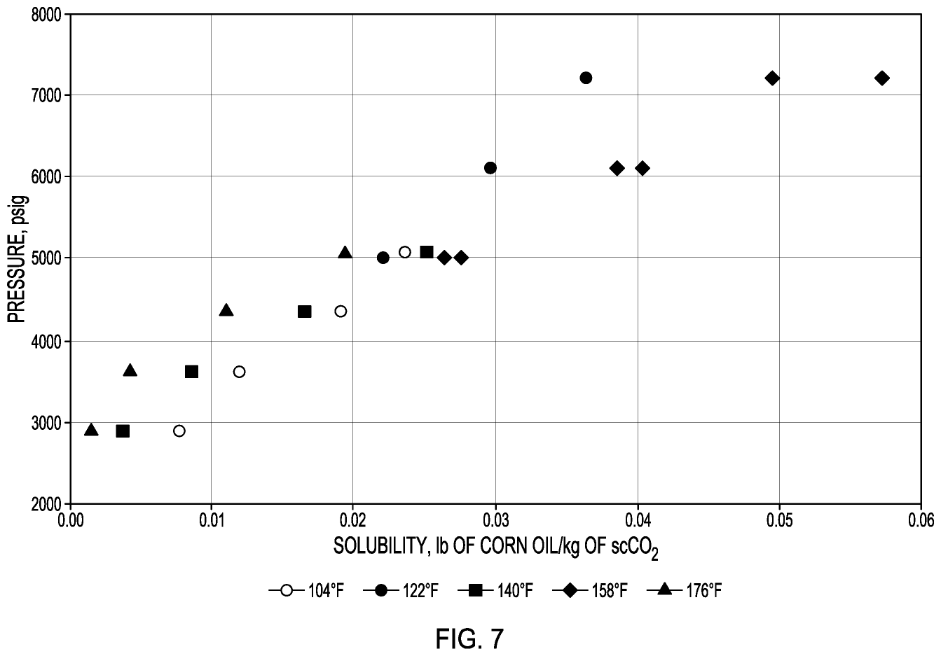

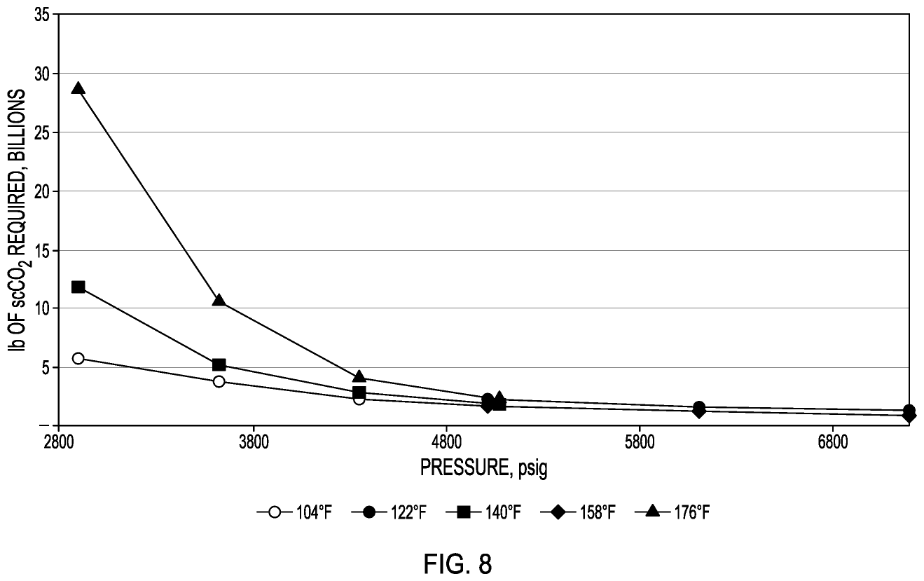

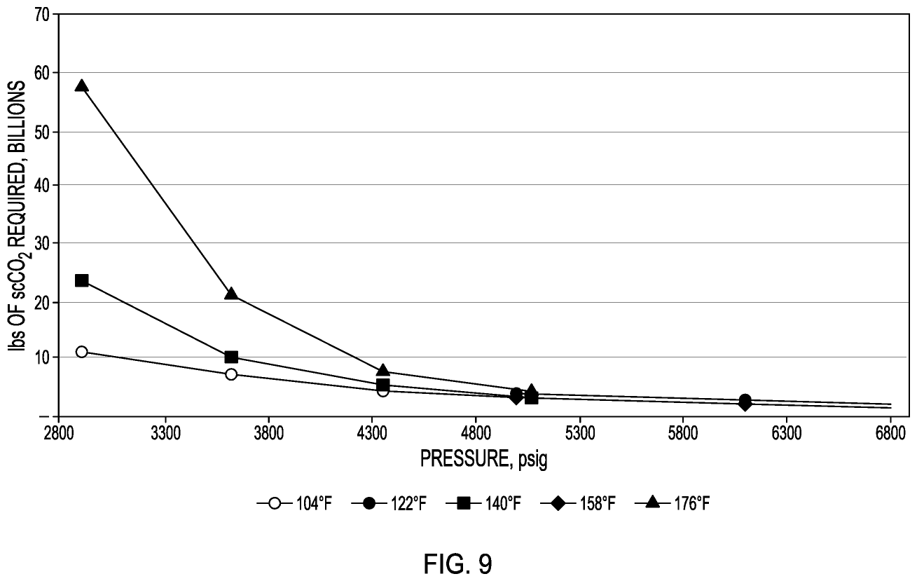

The solubility of corn oil in scCO₂ was the basis of the model in this study and is shown in FIG. 7. The solubility trends upward as pressure increases, but increasing solubility reduces the amount of scCO₂ required for extraction. The largest impact on energy requirements in the extraction process was the mass of circulating scCO₂, which was the greatest for low-solubility conditions. The mass of scCO₂ required for each solubility condition is shown in FIG. 8 for DDGS and FIG. 9 for WS.

### Equipment Sizing.

Equipment was sized for DDGS and WS extraction conditions at the most and least energy-intensive conditions. The most energy-intensive conditions for DDGS and WS were at the lowest solubility factor value and the lowest separation pressure, while the least energy-intensive conditions were associated with the highest solubility value and the highest separation pressure. A comparison of equipment sizing for the most energy-intensive conditions is shown in Table 7 for DDGS and WS, while the least energy-intensive conditions are shown in Table 8 for DDGS and WS.

The corn oil extractor sizing specifications listed were calculated based on the solids flow rate of DDGS and WS and the operating pressure. The separator design was simplified as a two-phase separator with a conservative length-to-diameter ratio of 5. The remaining equipment, such as pumps, heaters, and coolers, was sized in Aspen Hysys.

The capital expenses discussed in the report only accounted for the price of the extractor vessel and neglected the remaining equipment. The preliminary equipment specifications may be used as a design basis for a subsequent study.

TABLE 7
Comparison of Equipment Sizes for the Most Energy-Intensive
Condition for DDGS and WS.

| | | |
|---|---|---|
| Factor, units | DDGS | WS |

Extraction Conditions

| Pressure psig | 2900 | |
|---|---|---|
| Temperature, ° F. | 176 | |
| Flow Rate, | 28572 | 57144 |
| MMlb/yr | | |

Separation Conditions

| Pressure, psig | 1088 | |
|---|---|---|
| Temperature, ° F. | 158 | |
| Flow Rate, | 27143 | 54287 |
| MMlb/yr | | |
| Solids Flow Rate, | 450 | 4045 |
| MMlb/yr | | |
| Equipment | | |
| Description | Equipment Specifications | |
| scCO₂ Pump | Process Fluid = CO₂ | Process Fluid = CO₂ |
| | Flow Rate = 28,572 MMlb/yr | Flow Rate = 57,144 MMlb/yr |
| | Inlet Pressure = 1510 psig | Inlet Pressure = 1510 psig |
| | Outlet Pressure = 2902 psig | Outlet Pressure = 2902 psig |
| | Inlet Temperature = 85° F. | Inlet Temperature = 85° F. |
| | Outlet Temperature = 115° F. | Outlet Temperature = 115° F. |
| | Drive Type = Electric | Drive Type = Electric |
| | Drive Size = 9530 hp | Drive Size = 19,000 hp |
| scCO₂ Heater | Process Fluid = CO₂ | Process Fluid = CO₂ |
| | Process Fluid Inlet | Process Fluid Inlet |
| | Temperature = 115° F. | Temperature = 115° F. |
| | Process Fluid Outlet | Process Fluid Outlet |
| | Temperature = 176° F. | Temperature = 176° F. |
| | dP = 2 psi | dP = 2 psi |
| | Duty = 48,610 hp | Duty = 97,000 hp |
| Corn Oil Extractor | Solids Flow Rate = | Solids Flow Rate = |
| | 450 MMlb/yr | 4045 MMlb/yr |
| | Design Operating | Design Operating |
| | Pressure = 2900 psig | Pressure = 2900 psig |
| | Retention Time = 1 hr | Retention Time = 1 hr |
| | Seam-to-Seam Length = 28.0 ft | Seam-to-Seam Length = 28.1 ft |
| | End-to-End Length = 33.0 ft | End-to-End Length = 33.1 ft |
| | Diameter = 5 ft | Diameter = 5 ft |
| | Wall Thickness = 4.3 inches | Wall Thickness = 4.3 inches |
| | Number of Vessels = 3 | Number of Vessels = 12 |
| Corn Oil and | Process Fluid = CO₂ and | Process Fluid = CO₂ smf |
| scCO₂ Separator | Corn Oil | Corn Oil |
| | Diameter = 55 inches | Diameter = 59 inches |
| | Length = 23 ft | Length = 25 ft |
| | Flow Rate = 27,143 MMlb/yr | Flow Rate = 54,287 MMlb/yr |
| | Operating Pressure = 1088 psig | Operating Pressure = 1088 psig |
| | Operating Temperature = 158° F. | Operating Temperature = 158° F. |
| | Number of Vessels = 3 | Number of Vessels = 5 |
| Recycle Cooler | Duty = 110,000 hp | Duty = 220,000 hp |
| | Process Fluid Inlet | Process Fluid Inlet |
| | Temperature = 158° F. | Temperature = 158° F. |
| | Process Fluid Outlet | Process Fluid Outlet |
| | Temperature = 75° F. | Temperature = 75° F. |
| | dP = 2 psi | dP = 2 psi |
| Recycle Pump | Process Fluid = CO₂ | Process Fluid = CO₂ |
| | Flow Rate = 27,143 MMlb/yr | Flow Rate = 54,287 MMlb/yr |
| | Inlet Pressure = 1086 psig | Inlet Pressure = 1086 psig |
| | Outlet Pressure = 1510 psig | Outlet Pressure = 1510 psig |
| | Inlet Temperature = 75° F. | Inlet Temperature = 75° F. |
| | Outlet Temperature = 85° F. | Outlet Temperature = 85° F. |
| | Drive Type = Electric | Drive Type = Electric |
| | Drive Size = 2800 hp | Drive Size = 5500 hp |

TABLE 8
Comparison of Equipment Sizes for the Least Energy-Intensive
Condition for DDGS and WS.

| | | |
|---|---|---|
| Factor, units | DDGS | WS |

Extraction Conditions

| Pressure, psig | 7194 | |
|---|---|---|
| Temperature, ° F. | 158 | |
| Flow Rate, MMlb/yr | 769 | 1538 |

Separation Conditions

| Pressure, psig | 1450 | |
|---|---|---|
| Temperature, ° F. | 104 | |
| Flow Rate, MMlb/yr | 731 | 1462 |
| Solids Flow Rate, | 450 | 4045 |
| MMlb/yr | | |
| Equipment Description | Equipment Specifications | |
| scCO₂ Pump | Process Fluid = CO₂ | Process Fluid = CO₂ |
| | Flow Rate = 769 MMlb/yr | Flow Rate = 1538 MMlb/yr |
| | Inlet Pressure = 1510 psig | Inlet Pressure = 1510 psig |
| | Outlet Pressure = 7196 psig | Outlet Pressure = 7196 psig |
| | Inlet Temperature = 85° F. | Inlet Temperature = 85° F. |
| | Outlet Temperature = 188° F. | Outlet Temperature = 188° F. |
| | Drive Type = Electric | Drive Type = Electric |
| | Drive Size = 1048 hp | Drive Size = 2096 hp |
| scCO₂ Cooler | Process Fluid = CO₂ | Process Fluid = CO₂ |
| | Process Fluid Inlet Temperature = | Process Fluid Inlet Temperature = |
| | 188° F. | 188° F. |
| | Process Fluid Outlet Temperature = | Process Fluid Outlet Temperature = |
| | 158° F. | 158° F. |
| | dP = 2 psi | dP = 2 psi |
| | Duty = 454 hp | Duty = 909 hp |
| Corn Oil Extractor | Solids Flow Rate = 450 MMlb/yr | Solids Flow Rate = 4045 MMlb/yr |
| | Design Operating Pressure = 7200 | Design Operating Pressure = 7200 |
| | psig | psig |
| | Retention Time = 1 hr | Retention Time = 1 hr |
| | Seam-to-Seam Length = 28.0 ft | Seam-to-Seam Length = 28.1 ft |
| | End-to-End Length = 33.0 ft | End-to-End Length = 33.1 ft |
| | Diameter = 5 ft | Diameter = 5 ft |
| | Wall Thickness = 10 inches | Wall Thickness = 10 inches |
| | Number of Vessels = 3 | Number of Vessels = 12 |
| Corn Oil and scCO₂ | Process Fluid = CO₂ and Corn Oil | Process Fluid = CO₂ and Corn Oil |
| Separator | Diameter = 34 inches | Diameter = 43 inches |
| | Length = 14 ft | Length = 18 ft |
| | Flow Rate = 731 MMlb/yr | Flow Rate = 1462 MMlb/yr |
| | Operating Pressure = 1450 psig | Operating Pressure e= 1450 psig |
| | Operating Temperature = 104° F. | Operating Temperature = 104° F. |
| | Number of Vessels = 1 | Number of Vessels = 1 |
| Corn Oil and scCO₂ | Process Fluid = CO₂ and Corn Oil | Process Fluid = CO₂ and Corn Oil |
| Separator | Diameter = 34 inches | Diameter = 43 inches |
| | Length = 14 ft | Length = 18 ft |
| | Flow Rate = 731 MMlb/yr | Flow Rate = 1462 MMlb/yr |
| | Operating Pressure = 1450 psig | Operating Pressure = 1450 psig |
| | Operating Temperature = 104° F. | Operating Temperature = 104° F. |
| | Number of Vessels = 1 | Number of Vessels = 1 |
| Recycle Cooler | Duty = 727 hp | Duty = |
| | Process Fluid Inlet Temperature = | Process Fluid Inlet Temperature = |
| | 104° F. | 104° F. |
| | Process Fluid Outlet Temperature = | Process Fluid Outlet Temperature = |
| | 84° F. | 84° F. |
| | dP = 2 psi | dP = 2 psi |
| Recycle Pump | Process Fluid = CO₂ | Process Fluid = CO₂ |
| | Flow Rate = 731 MMlb/yr | Flow Rate = 1462 MMlb/yr |
| | Inlet Pressure = 1448 psig | Inlet pressure e= 1448 psig |
| | Outlet Pressure = 1510 psig | Outlet pressure e = 1510 psig |
| | Inlet Temperature = 84° F. | Inlet Temperature = 84° F. |
| | Outlet Temperature = 85° F. | Outlet Temperature = 85° F. |
| | Drive Type = Electric | Drive Type = Electric |
| | Drive Size = 11 hp | Drive Size = 1454 hp |

### Results.

In the simulation, the mass flow rate, temperature, and pressure were adjusted based on solubility conditions. The solubility of the corn oil in scCO₂ dictated the mass of the solvent required for extraction as well as the associated temperature and pressure conditions in the extractor vessel. Generally, an increase in pressure and temperature resulted in increased solubility, as shown previously in FIG. 3. The solubility is inversely proportional to the scCO₂ mass, thus higher values for pressures are correlated with a decrease in required scCO₂ for solute extraction. The relationship between temperature and solubility does not follow a linear trend. At a fixed pressure, the solubility is inversely related to temperature between 2900 and 4350 psi, but near the crossover point, 5004 psig and 158° F., there is no distinct trend. When pressures exceed 6106 psi, the solubility begins increasing with rise in temperature. The ranges for circulating scCO₂ masses in the process are summarized in Table 9.

TABLE 9
Minimum and Maximum Values for the scCO₂ Requirements for
DDGS and WS Throughout Each Solubility Condition.

| | DDGS scCO₂ Requirements, | WS scCO₂ Requirements, |
|---|---|---|
| | MMlb/year | MMlb/yr |
| Maximum | 29,000 | 57,000 |
| Minimum | 770 | 1500 |

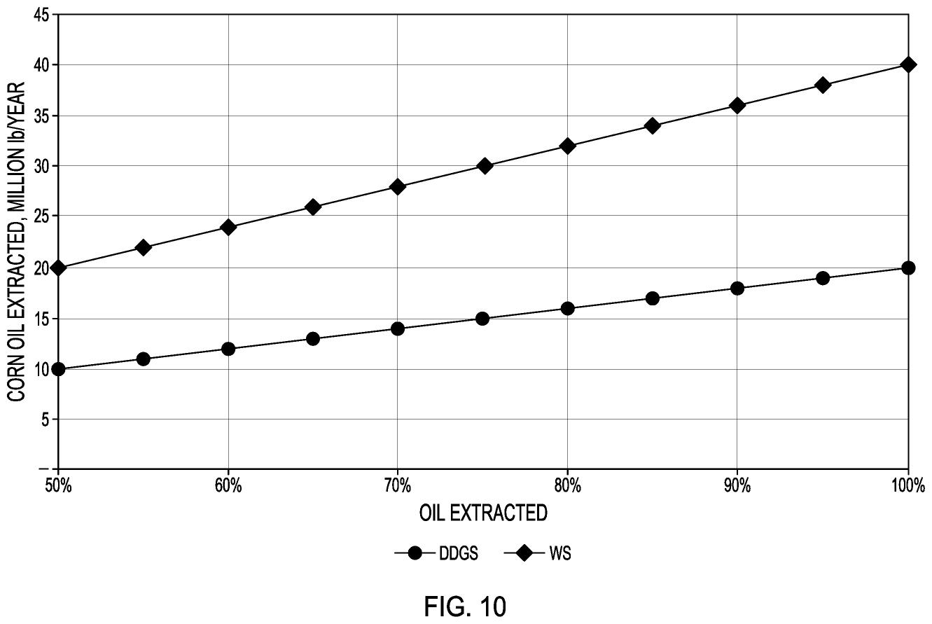

Although the study assumed 100% oil extraction, the actual recovery will be determined during future iterations; however, it will vary with extraction conditions due to a variety of factors including pressure and temperature. The percentage of extracted oil and corn oil product is linearly related, as shown in FIG. 10. A lower extraction efficiency would potentially create oil carryover in the liquid CO₂ recycle stream and result in undesirable accumulations over time.

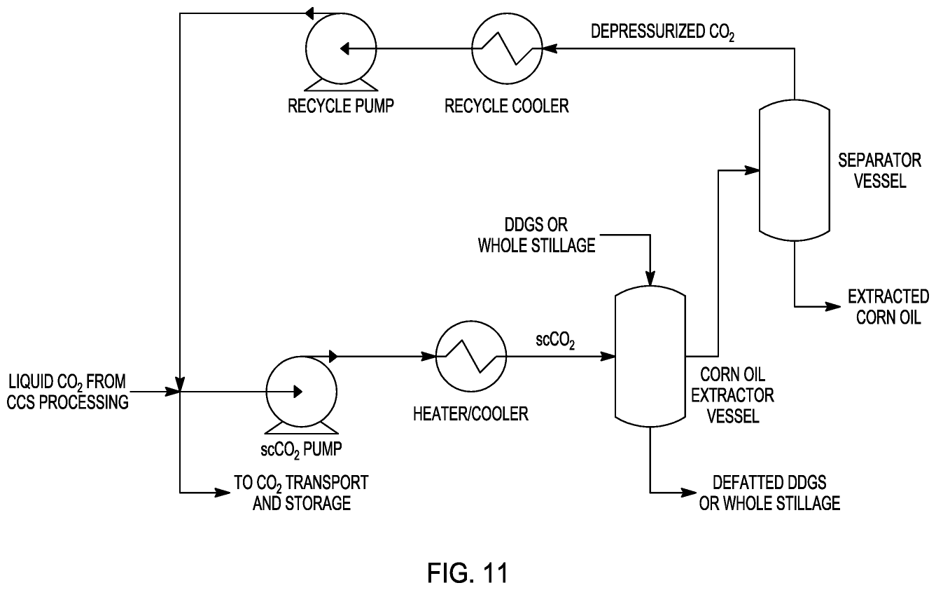

The conditions for separation of the oil and solvent set the temperature and pressure of the depressurized CO₂ exiting the separator vessel. The depressurized CO₂ stream contains 5% less mass than the respective scCO₂ stream because of CO₂ losses during the extraction process. An illustration of the process simulation is shown in FIG. 11. The energy consumption of the recycle pump, recycle cooler, scCO₂ pump, and heater/cooler were considered for total power requirements.

The energy requirements to process liquid CO₂ at injection well conditions to supercritical conditions were considered in the simulation. Aspen Hysys software was used to determine the power for the most energy-intensive equipment in the process, the pumps and heat exchangers. The pressure had the greatest impact on energy requirements for both DDGS and WS. Higher pressures reduced the required scCO₂ mass flow rate for extraction, therefore reducing the overall energy requirements. Similarly, higher pressures in the separation vessel resulted in lower energy requirements for the recycle pump and cooler because of the smaller solvent volume and smaller pressure and temperature differentials between separation conditions and CCS conditions. Based on energy requirement trends, it can be concluded that processing lower scCO₂ volumes at higher pressures is more efficient than processing larger scCO₂ volumes at lower pressures.

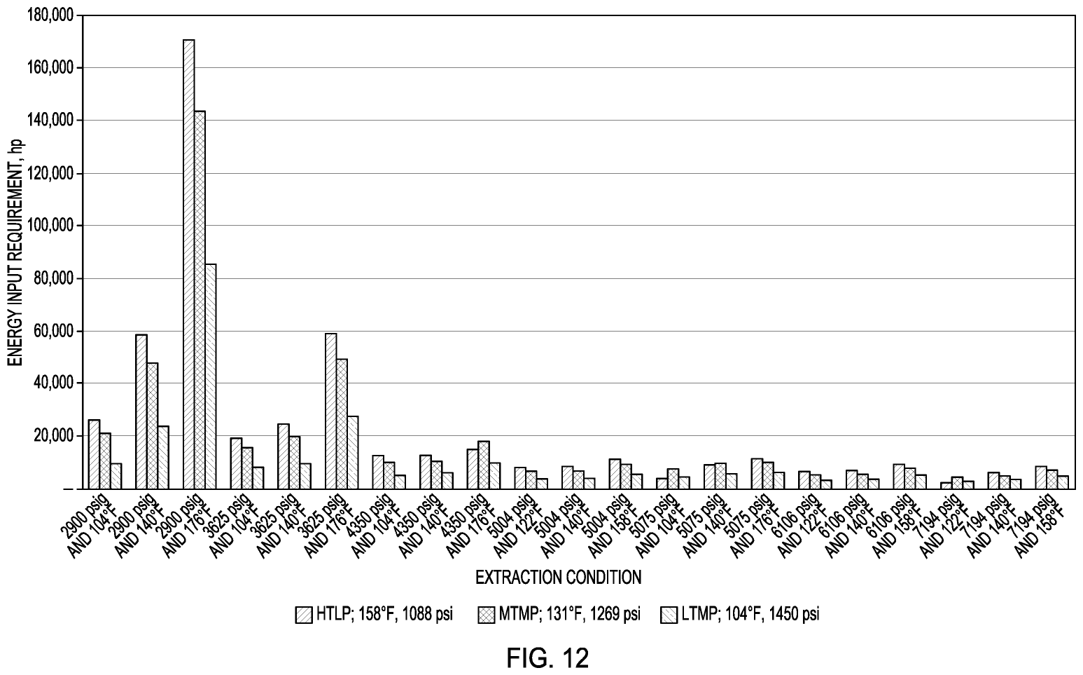

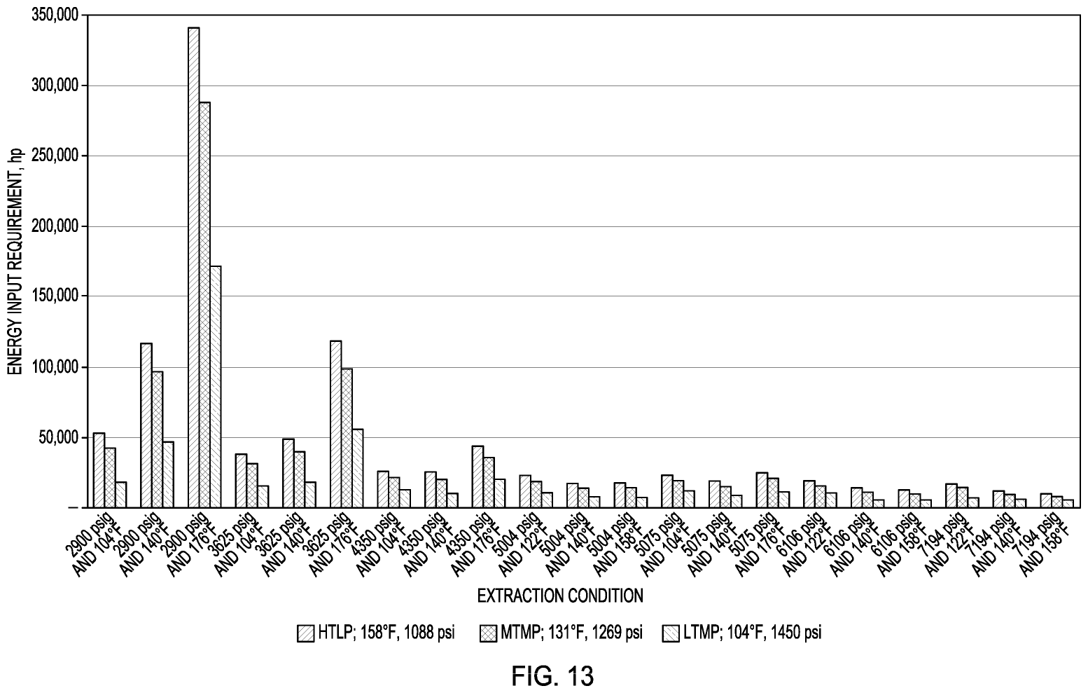

The total power consumption to pressurize CO₂ from injection well conditions to supercritical state with recycling after solute separation ranged from 1.4 to 130 MW for DDGS and 3.0 to 250 MW for WS. The utility requirements for DDGS and WS varied in scale because of the greater oil fraction in WS, but trends remained the same throughout the conditions. A comparison of each condition and respective energy requirement is shown in FIG. 12 for DDGS and FIG. 13 for WS. FIGS. 12-13 depict the energy required for extraction at each temperature and pressure condition along with the three separation conditions: HTLP, MTMP, and LTHP. In agreement with the discussed trends for power requirements, the conditions with the lowest requirement were the highest pressure condition analyzed at 7194 psig coupled with high-pressure separation at 1450 psig.

### Example 3. Integration of scCO₂-Facilitated Extraction with CCUS: Economic Analysis

### Capital Expenditures.

Most of the capital expenditures for the extraction and separation system lie within the extraction vessel. To estimate the cost for the extraction vessel to an accuracy of #: 100%, scaling factors and assumptions were applied to current commercially available options. The Vitalis extraction vessels, Q90 and R400, were chosen for this estimation because of their current use in other scCO₂ extractions. The base specifications for these systems can be seen in Table 10.

TABLE 10
Design Specifications for Vitalis scCO₂ Extraction Systems.

| | Q90 | R400 |
|---|---|---|
| Maximum Extractor Volume, ft³ | 1.6 | 7.1 |
| Maximum Total Extraction Volume, ft³ | 3.2 | 14.1 |
| Maximum CO₂ Flow Rate. lb/min | 33.1 | 48.5 |
| Standard Operating Pressure Range, psig | 500-2000 | |
| Feed Capacity, lb/day | 175 | 778 |

Option:

| | |
|---|---|
| Extended Operating Pressure Range, psig | 500-4800 |

Complete System:

| | | |
|---|---|---|
| Estimated Initial Sales Price, 2018 | $780,000 | $1,000,000 |

As the system specifications presented in Table 10 are different from the operating conditions of the extraction process for DDGS and WS, several other factors must be considered. First, because of the significant scale difference, the altered mass flow rates need to be accounted for. Furthermore, because of the higher operating pressures of 3000-7000 psig, adjustments must be made for the increased scCO₂ solubility and an increase in metal. Lastly, because of the higher flow rates of scCO₂, reduced residence times must also be taken into consideration.

The mass of the scCO₂ required for extraction was determined by the solubility at each temperature and pressure. The solubility was represented as kg of scCO₂ solvent per lb of corn oil solute.

Amount of scCO₂ solvent required for corn oil extraction:

$$\frac{lbs of Corn Oil}{1} x \frac{kg of ScCO 2}{lbs of Corn Oil} x \frac{22 lb}{kg} = ScCO 2 ( kg ) \qquad ( Eq . 1 )$$

Estimations of cost based on scaling of factors:

$$Cost of Equipment 2 = Cost of Equipment 1 * {( \frac{Size of Equipment 2}{Size of Equipment 1} )}^{0.5} \qquad ( Eq . 2 )$$

When evaluating the cost for the extraction system at the larger mass flow rates, the scaling formula was applied with a scaling factor of 0.5, while the R400 system served as a base value. The same formula and scaling factor were also used to account for the differences in pressure for the systems. The estimated costs for the equipment can be seen in Table 11.

TABLE 11
Extraction Vessel Costs Based on Feed Type.

| | DDGS Feed | WS Feed |
|---|---|---|
| Pressure, psi | Cost, millions of $ | Cost, millions of $ |
| 2000 | 40 ± 40 | 120 ± 120 |
| 3000 | 14 ± 14 | 42 ± 42 |
| 5000 | 3 ± 3 | 9 ± 9 |
| 7000 | 2 ± 2 | 5 ± 5 |

### Operational Expenditures.

The total power requirements at each condition were used to perform a preliminary economic analysis. The analysis calculated revenue that factored corn oil sales and utility costs. The first iteration of profitability calculations was sales revenue minus utility costs. The electricity prices in North Dakota and the price of corn oil were forecasted until 2027. The minimum, median, and maximum of the forecasted values were used in the economic analysis and are shown in Table 12. The price-forecasting graphs are found in FIGS. 4-5.

TABLE 12
Minimum, Median, and Maximum for the Industrial Price of
Electricity in North Dakota and the Wholesale Price of Corn Oil.

| | Electricity Price, $/kWh | Corn Oil Price, $/lb |
|---|---|---|
| Minimum | 0.073 | 0.269 |
| Median | 0.088 | 0.541 |
| Maximum | 0.095 | 0.642 |

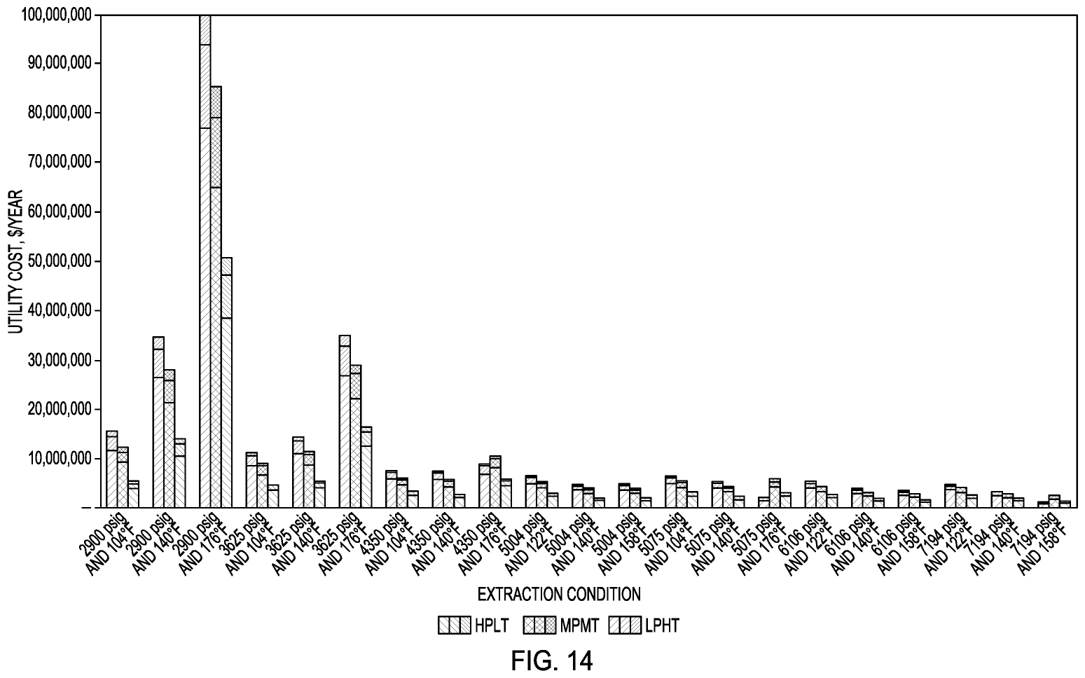

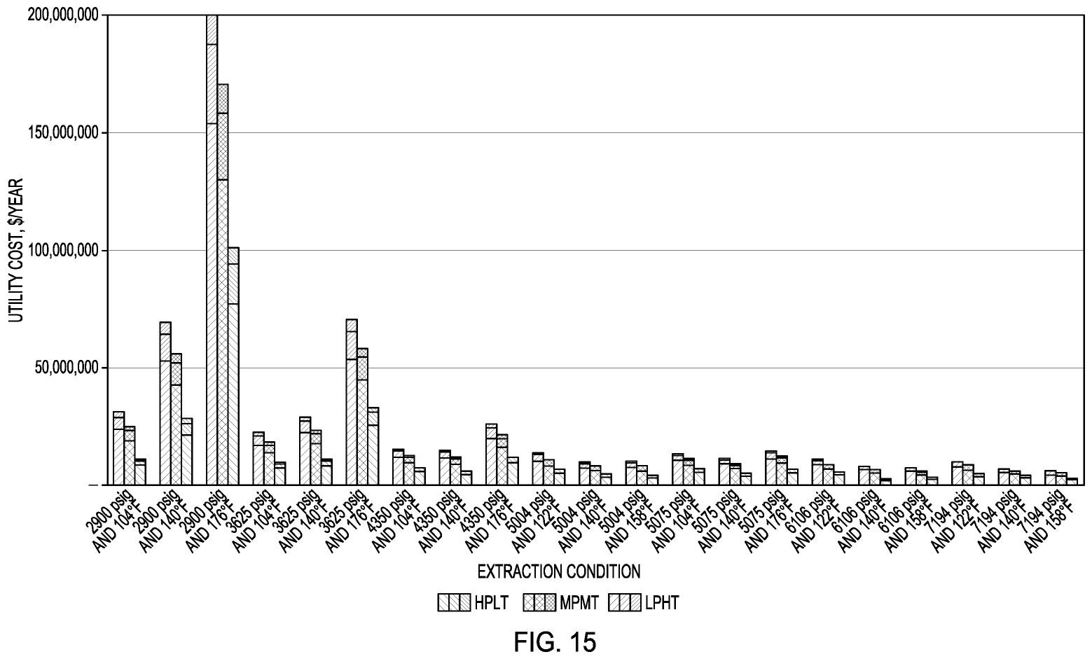

The first iteration of profitability calculations was sales revenue minus utility costs. The difference was evaluated at a minimum, median, and maximum value with respect to the price of utilities and corn oil revenue. The utility cost follows the same trend as the power requirements, whereas the high-pressure extraction conditions and separation conditions are the least energy-intensive. The revenue for corn oil remains the same throughout each condition within the analysis for DDGS and WS, while the price for utilities varies at each condition and therefore requires increased granularity in its description. The utility prices for each condition are compared with respect to extraction and separation conditions in FIG. 14 for DDGS and FIG. 15 for WS. The utility prices are an extension of the power requirements for each condition and follow the same trends previously discussed. The graphs for both DDGS and WS display yearly utility prices at a minimum, median, and maximum value for the unit price of electricity. The columns in the graph are color-coded to represent the three separation conditions analyzed at each extraction condition with increasingly darker shades for an increase in price values.

### Revenues.

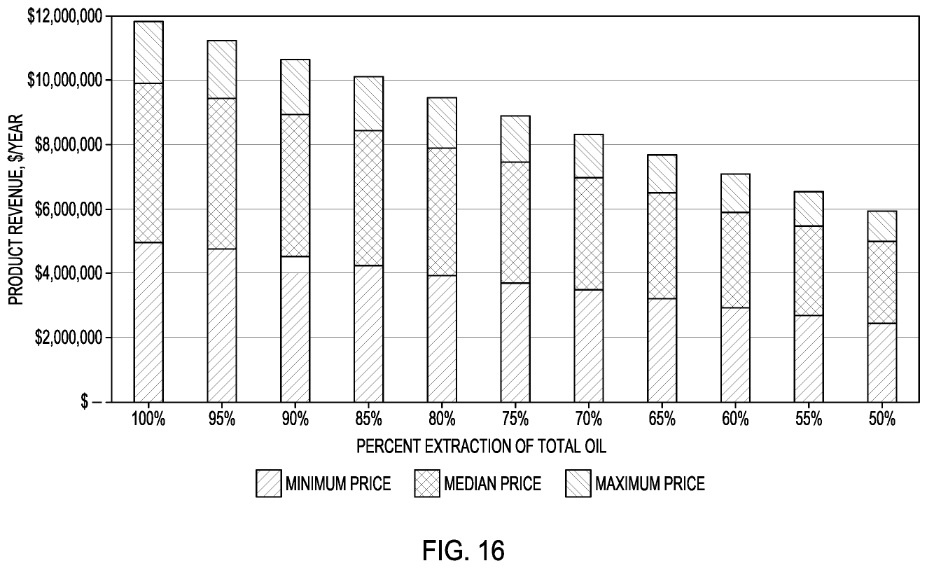

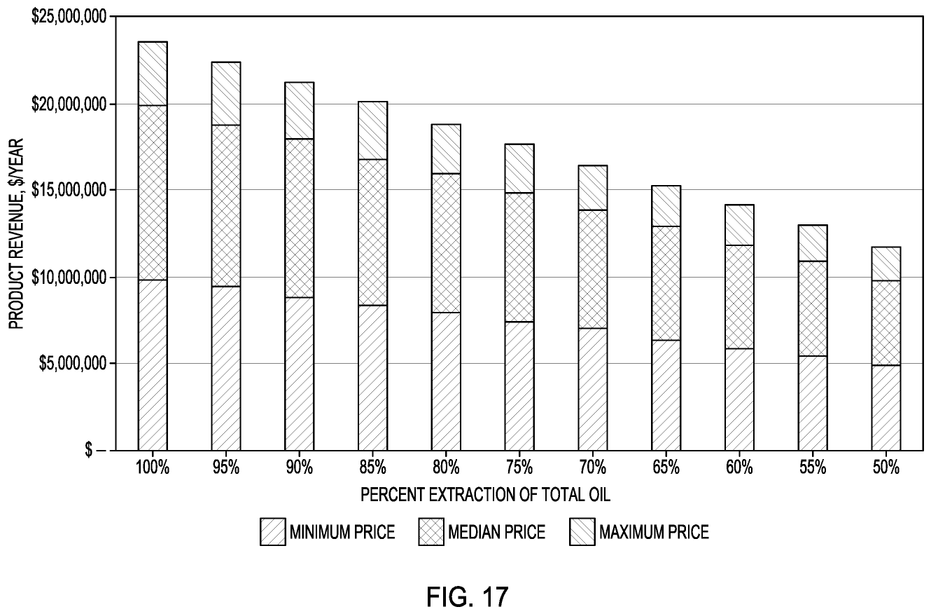

The calculated revenue factors the sales from extracted corn oil from DDGS and WS. Previous calculations assumed 100% of the corn oil was extracted, while experimental values are likely to vary. The variance of total extracted oil and its impact on product revenue is represented in FIG. 16 for DDGS and FIG. 17 for WS.

### Overall Profitability.

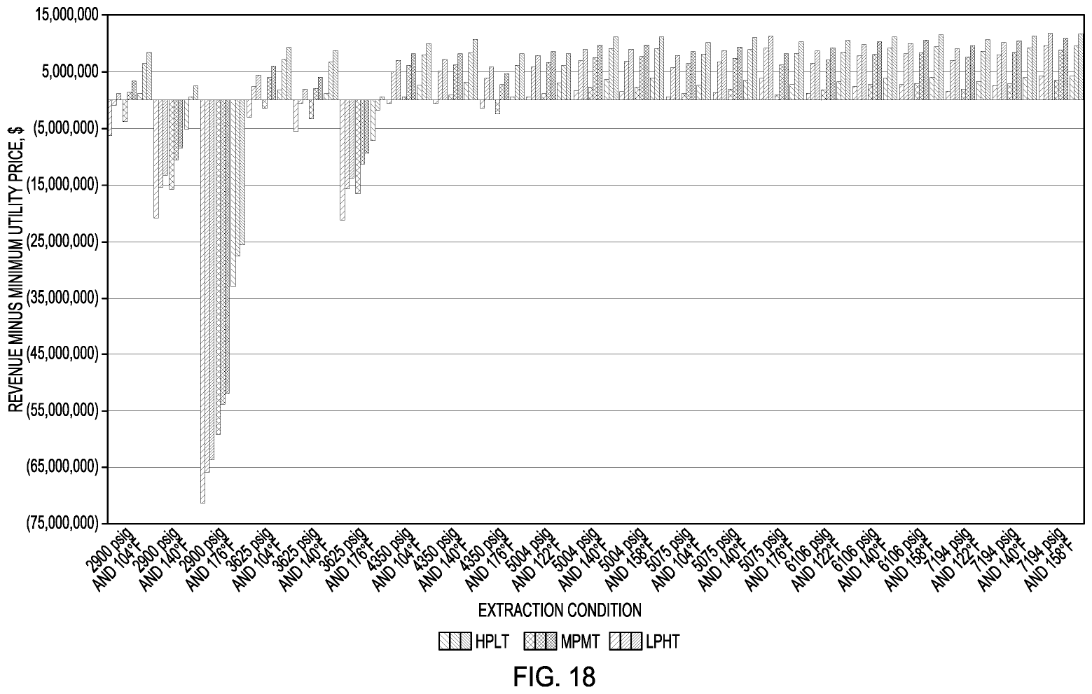

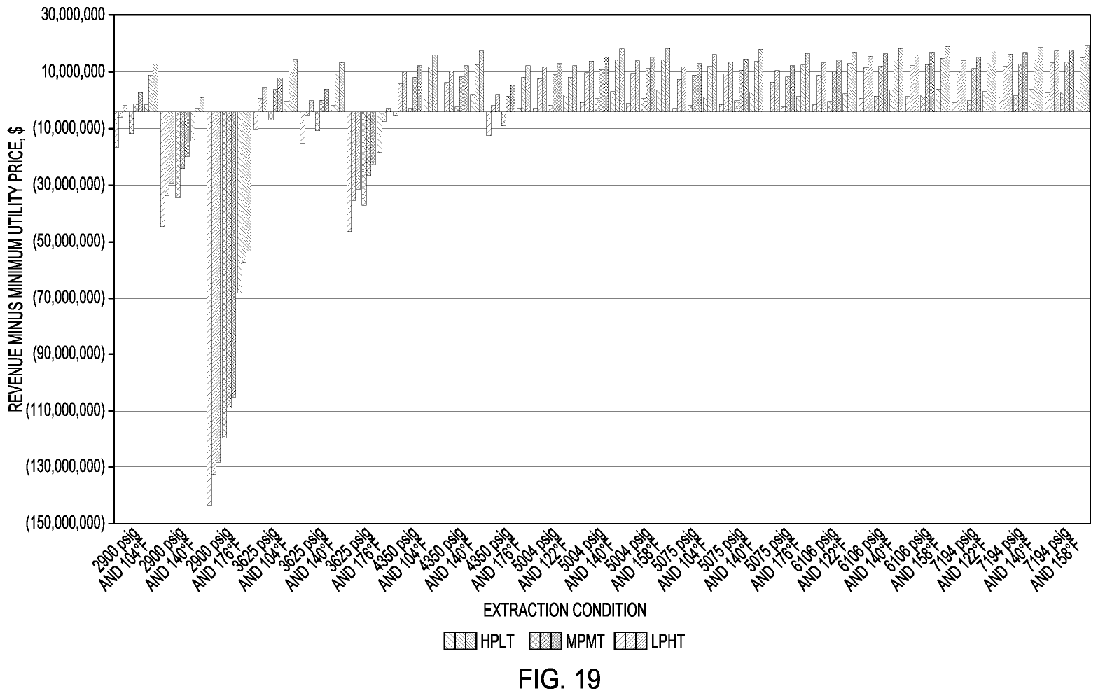

The calculated operating expenditure only included the price of utilities, which was predicted as the predominant expense. The anticipated utility price at various extraction and separation conditions subtracted from the calculated revenue with 100% extraction of the oil component is shown in FIG. 18 for DDGS and FIG. 19 for WS.

A comprehensive economic analysis would account for additional operating costs such as wages, overhead costs, taxes, tax credits, and depreciation as well as capital expenses. Therefore, a margin exists between revenue and costs that could be defined in a subsequent study with additional detail.

### Example 3. Extraction of Corn Oil from DDGS Using scCO₂

### Oil Concentration.

Containing more than 80% of the oil in corn, intact corn germ is an attractive extraction target. To its disadvantage, dry grinding immediately crushes the germ and distributes the oil throughout the mass which reduces oil concentration from roughly 40% dry weight down to 4% dry weight. The dilution decreases the potential driving force for extraction and increases the volume of material that must be treated to extract the oil. The question arises as to what the next most opportune stream is, one which could serve as an oil source and has a high concentration and low volume. Another factor is the accessibility of the oil: is the oil chemically tied into the phase, does the phase inhibit mass transport (e.g., tortuosity in solids, viscosity in liquids), and other influences.

Given the dilution that occurs during grinding and slurrying and the viscosity of the grind, there is justification to assume that extraction early in the process might be challenging. Fermentation reduces the amount of starch (sugar) in the broth by converting it to alcohol and carbon dioxide, but it adds biomass. Thus, starting with commonly accepted values of 56 lb/bu that produces 2.7 gal/bu (18 lb/bu) and 18 lb/bu of carbon dioxide, there could be a reduction of roughly 36 lb/bu upstream of whole stillage (WS) (Davis, 2001).

### Experimental.

For the following described experiments, corn oil was extracted from eight feedstocks sampled from various locations at two North Dakota ethanol plants, indicated in Table 13.

Multiple variables can affect the oil extraction yield, such as solvent, solvent ratio, temperature, and pressure. The test conditions were chosen after performing a review of previous oil extraction studies. The operating conditions chosen for the discussed project span the temperature range indicated by the literature and fall within the typical range of pressures in the literature. scCO₂ extractions with one feedstock (Sample 8), two temperatures (45° and 60° C.), and three pressures (3000, 3500, and 3750 psi) were studied. The feedstock and test duration were kept constant.

TABLE 13
Various Feedstocks Obtained from North Dakota Ethanol Plants.

| Sample | | Sample | | |
|---|---|---|---|---|
| No. | Sample Type | Location | Sample Plant | Date |
| 1 | Milled corn | Post-hammer | Hankinson | February |
| | | mill | Renewable Energy | 2021 |
| 2 | Liquefaction | Liquefaction | Hankinson | February |
| | tank | tank | Renewable Energy | 2021 |
| 3 | Fermenter | Fermenter | Hankinson | February |
| | | | Renewable Energy | 2021 |
| 4 | Empty beer | Beer column | Hankinson | February |
| | column bottom | | Renewable Energy | 2021 |
| 5 | Full beer | Beer column | Hankinson | February |
| | column bottom | | Renewable Energy | 2021 |
| 6 | Backset | Post- | Hankinson | February |
| | | centrifuges | Renewable Energy | 2021 |
| 7 | Dried distillers | After dryers | Hankinson | February |
| | grains with | | Renewable Energy | 2021 |
| | solubles | | | |
| | (DDGS) | | | |
| 8 | DDGS | After dryers | Dakota Spirit Plant | November |
| | | | | 2019 |

### Equipment.

To perform scCO₂ extraction of corn oil from DDGS (Table 13, Sample 8), a set of five 25-mL water reactors (Series No. 4502109254-24) were utilized to achieve the desired operating conditions. The reactors had a maximum operating pressure of 10,000 psi and a maximum operating temperature of 75° C. A Teledyne ISCO syringe pump Model 260D with a cooling jacket was filled from a CO₂ cylinder to cool and pressurize the gas and connected in series to a Teledyne ISCO syringe pump Model 500D to feed and pressurize the reactor system. The second syringe pump was utilized to monitor and control pressure in the set of reactors.

### Experimental Procedures.

To prepare for each run, 25 grams of milled DDGS was loaded into each reactor. The weight of each reactor was recorded, and the reactors were reattached to the system. Once the reactors were attached, the system was pressurized to check for leaks. The jacketed pump was then filled and drained to the second pump until the second pump was full. The second pump was then set to the desired pressure for each run (3000, 3500, or 3750 psi), and the oven was set to the desired temperature for each run (113° or 140° F.) according to the test plan (Table 14). Once the pump was at pressure and the oven up to temperature, the valves from the pump and into each reactor were opened. The system was then allowed to sit for 4 hours. The valves into each reactor were closed and then reopened one at a time along with the valves leaving the reactors so each reactor could be drained. Once each reactor was drained, the valves leaving the reactors were then closed and the valves entering each reactor were reopened. The system was then repressurized and let to sit for an additional 16 hours. After the 16 hours, the reactors were again drained. The oven was then shut off and the reactors taken down. The oil collected from draining the reactors was measured along with the final weights of the reactors.

TABLE 14
scCO₂ Extraction Test Plan.

| Test | Temperature, | Duration, | Pressure, | DDGS, |
|---|---|---|---|---|
| No. | ° F. | hours | psig | g |
| 1 | 113 | 20 | 3000 | 25 |
| 2 | 113 | 20 | 3500 | 25 |
| 3 | 113 | 20 | 3750 | 25 |
| 4 | 140 | 20 | 3000 | 25 |
| 5 | 140 | 20 | 3500 | 25 |
| 6 | 140 | 20 | 3750 | 25 |

### Results and Discussion.

Several industrial partners have previously shown interest in the concept of scCO₂ extraction of corn oil for the potential benefit of lowering the carbon intensity of the products. This study focused on six experiments, detailed in Table 15, operating at three pressures and two temperatures with DDGS (Sample 8, Table 13). Table 14 indicates total mass extracted as a percent of the original sample mass.

TABLE 15
Results of scCO₂ Extraction

| | 3000 psi | 3500 psi | 3750 psi |
|---|---|---|---|
| 113° F. | 3.6% | 3.9% | 3.7% |
| 140° F. | 3.4% | 2.6% | 3.4% |

No correlation can be conclusively made from the results obtained, as increased temperature and pressure did not result in an increase in yield. The overall yield of each of the six trials is lower in comparison to the known oil content of DDGS, as typically it has a relatively low oil content ranging from 5% to 12% (Moreau and others, 2010); however, DDGS obtained at North Dakota ethanol plants are typically 5% oil. During operation of the reactor system, issues with plugging of the frit and tubing lines resulted in liquid being trapped throughout the apparatus. While attempting to unplug the system following operation, oil was lost or trapped within the system and was unable to be completely collected. During disassembly of the system following each run, oil was discovered throughout the tubing and fittings. Each reactor mass was recorded both before and after operation to determine total mass lost. This mass was not able to be used to obtain an accurate oil extraction because of the amount of DDGS lost to other components of the system. The difficulties during each test resulted in inaccurate results for the scCO₂ experiments. In order to achieve accurate results, modifications need to be made to the reactor system or a different system should be utilized in future work. Additionally, in order to study various feedstocks (Samples 1-7), a different reactor system would be needed to accommodate samples with a high liquid-to-solids ratio.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

### Exemplary Aspects.

The following exemplary aspects are provided, the numbering of which is not to be construed as designating levels of importance:

Aspect 1 provides a method of extracting one or more oils, the method comprising:
compressing CO₂ gas produced by fermentation of a grain, to form supercritical CO₂ (scCO₂), wherein the fermentation of the grain forms a spent grain; and
extracting the one or more oils from the spent grain with the scCO₂; and
separating the oil and the scCO₂.

Aspect 2 provides the method of Aspect 1, wherein the grain comprises wheat, sorghum, barley, rye, cassava, rice, triticale, corn, or a combination thereof.

Aspect 3 provides the method of any one of Aspects 1-2, wherein the grain comprises corn.

Aspect 4 provides the method of any one of Aspects 1-3, wherein the grain is in a ground and/or pulverized form.

Aspect 5 provides the method of any one of Aspects 1-4, wherein the fermentation of the grain produces ethanol.

Aspect 6 provides the method of any one of Aspects 1-5, wherein the spent grain comprises dried distillers grains with solubles (DDGS), whole stillage (WS), grain from downstream of a hammer mill, a liquefaction tank, a fermenter, a centrifuge, or a dryer, or a combination thereof.

Aspect 7 provides the method of any one of Aspects 1-6, wherein the spent grain comprises dried distillers grains with solubles (DDGS).

Aspect 8 provides the method of any one of Aspects 1-7, wherein the spent grain comprises whole stillage (WS).

Aspect 9 provides the method of any one of Aspects 1-8, wherein the spent grain is formed by the fermentation of the grain, and is optionally formed via steps further comprising distilling ethanol from the grain, centrifuging the grain, drying the grain, evaporation from the grain, or a combination thereof.

Aspect 10 provides the method of any one of Aspects 1-9, wherein the spent grain is formed via steps comprising removal of a portion of oil in the grain after the fermenting of the grain.

Aspect 11 provides the method of Aspect 10, wherein the removal of the portion of the oil in the grain comprises centrifugation.

Aspect 12 provides the method of any one of Aspects 1-11, wherein the fermentation of the grain and the extraction of the spent grain are performed at the same site.

Aspect 13 provides the method of any one of Aspects 1-12, wherein the fermentation of the grain and the extraction of the spent grain are performed within five miles of one another.

Aspect 14 provides the method of any one of Aspects 1-13, further comprising performing the fermentation of the grain.

Aspect 15 provides the method of any one of Aspects 1-14, wherein the compressing of the CO₂ gas comprises compressing to a pressure of 2900 psig (20 MPa) to 7200 psig (49.6 MPa).

Aspect 16 provides the method of any one of Aspects 1-15, wherein the compressing of the CO₂ gas comprises compressing to a pressure of 2900 psig (20 MPa) to 5100 psig (35.2 MPa).

Aspect 17 provides the method of any one of Aspects 1-16, wherein the compressing of the CO₂ gas comprises forming the scCO₂ at a temperature of 100° F. (37.8° C.) to 180° F. (82.2° C.).

Aspect 18 provides the method of any one of Aspects 1-17, wherein the compressing of the CO₂ gas comprises forming the scCO₂ at a temperature of 100° F. (37.8° C.) to 150° F. (65.6° C.).

Aspect 19 provides the method of any one of Aspects 1-18, wherein the extraction is performed at a pressure of 2900 psig (20 MPa) to 7200 psig (49.6 MPa).

Aspect 20 provides the method of any one of Aspects 1-19, wherein the extraction is performed at a pressure of 2900 psig (20 MPa) to 5100 psig (35.2 MPa).

Aspect 21 provides the method of any one of Aspects 1-20, wherein the extraction is performed at a temperature of 100° F. (37.8° C.) to 180° F. (82.2° C.).

Aspect 22 provides the method of any one of Aspects 1-21, wherein the extraction is performed at a temperature of 100° F. (37.8° C.) to 150° F. (65.6° C.).

Aspect 23 provides the method of any one of Aspects 1-22, wherein the extracting comprises placing the spent grain and the scCO₂ in intimate contact in an extractor.

Aspect 24 provides the method of any one of Aspects 1-23, wherein the scCO₂ used for the extracting further comprises scCO₂ recycled from the extracting.

Aspect 25 provides the method of any one of Aspects 1-24, wherein the separating comprises depressurizing the scCO₂, to form a used CO₂ and an extracted oil.

Aspect 26 provides the method of any one of Aspects 1-25, further comprising sequestering the used CO₂, storing the used CO₂, recycling the used CO₂ for reuse in the method, or a combination thereof.

Aspect 27 provides the method of any one of Aspects 25-26, further comprising recycling the used CO₂ stream for reuse in the method as a portion of the scCO₂ used for the extracting one or more oils from the spent grain.

Aspect 28 provides the method of Aspect 27, wherein the recycling comprises re-compressing the CO₂ to form scCO₂.

Aspect 29 provides the method of any one of Aspects 1-28, wherein the separating is performed in a separator.

Aspect 30 provides the method of any one of Aspects 1-29, wherein the separating is performed at a pressure of 1000 psig (6.9 MPa) to 2000 psig (13.8 MPa).

Aspect 31 provides the method of any one of Aspects 1-30, wherein the separating is performed at a pressure of 1000 psig (6.9 MPa) to 1500 psig (10.3 MPa).

Aspect 32 provides the method of any one of Aspects 1-31, wherein the separating is performed at a temperature of 80° F. (26.7° C.) to 200° F. (93.3° C.).

Aspect 33 provides the method of any one of Aspects 1-32, wherein the separating is performed at a temperature of 100° F. (37.8° C.) to 160° F. (71.1° C.).

Aspect 34 provides a method of extracting one or more oils, the method comprising:
compressing CO₂ gas produced by fermentation of corn, to form supercritical CO₂ (scCO₂), wherein the fermentation of the corn forms a used corn comprising dried distillers grains with solubles (DDGS), whole stillage (WS), or a combination thereof; and
extracting the one or more oils from the used corn with the scCO₂, wherein the fermentation of the grain and the extraction of the spent grain are performed within two miles of one another;
depressurizing the scCO₂, to form a used CO₂ and an extracted corn oil; and
recycling the used CO₂ stream for reuse in the method as a portion of the scCO₂ used for the extracting of the one or more oils from the used corn.

Aspect 35 provides a method of extracting one or more oils, the method comprising:
compressing CO₂ produced or available on-site to form supercritical CO₂ (scCO₂), and/or collecting scCO₂ produced or available on-site; and
extracting one or more oils from a fermented grain with the scCO₂.

Aspect 36 provides the method of Aspect 35, wherein the CO₂ or scCO₂ is formed from chemical manufacture, fuel manufacture, pharmaceutical manufacture, agribusiness, food or beverage manufacture, electricity generation, fermentation of a grain to form the fermented grain, or a combination thereof.

Aspect 37 provides a method of extracting one or more oils, the method comprising:
compressing CO₂ to form supercritical CO₂ (scCO₂), and/or collecting scCO₂; and
extracting one or more oils from an oil-bearing material comprising a plant product, algae, a waste product, an animal product, or a combination thereof.

Aspect 38 provides the method of Aspect 37, wherein the CO₂ that is formed and/or the scCO₂ that is collected is produced or available on-site at a site where the extracting is performed.

Aspect 39 provides the method of any one of Aspects 37-38, wherein the CO₂ that is formed and/or the scCO₂ that is collected is produced or available off-site away from a site where the extracting is performed.

Aspect 40 provides the method of any one of Aspects 37-39, wherein the CO₂ and/or scCO₂ is formed from chemical manufacture, fuel manufacture, pharmaceutical manufacture, agribusiness, food or beverage manufacture, electricity generation, fermentation of a grain to form a fermented grain that is the oil-bearing material, or a combination thereof.

Aspect 41 provides a system for of extracting one or more oils, the method comprising:
a compressor configured to compress CO₂ gas produced by fermentation of a grain, to form supercritical CO₂ (scCO₂), wherein the fermentation of the grain forms a spent grain; and
an extractor configured to extract the one or more oils from the spent grain with the scCO₂; and
a separator configured to depressurize the scCO₂ to separate the oil and the scCO₂.

Aspect 42 provides the apparatus, method, composition, or system of any one or any combination of Aspects 1-41 optionally configured such that all elements or options recited are available to use or select from.

What is claimed is:

1. A method of extracting one or more oils, the method comprising:
compressing CO₂ gas produced by fermentation of a grain, to form supercritical CO₂ (scCO₂), wherein the fermentation of the grain forms a spent grain; and
extracting the one or more oils from the spent grain with the scCO₂; and
separating the oil and the scCO₂.

2. The method of claim 1, wherein the grain comprises wheat, sorghum, barley, rye, cassava, rice, triticale, corn, or a combination thereof.

3. The method of claim 1, wherein the grain comprises corn.

4. The method of claim 1, wherein the spent grain comprises dried distillers grains with solubles (DDGS), whole stillage (WS), grain from downstream of a hammer mill, a liquefaction tank, a fermenter, a centrifuge, or a dryer, or a combination thereof.

5. The method of claim 1, wherein the spent grain comprises dried distillers grains with solubles (DDGS).

6. The method of claim 1, wherein the spent grain comprises whole stillage (WS).

7. The method of claim 1, wherein the fermentation of the grain and the extraction of the spent grain are performed within five miles of one another.

8. The method of claim 1, further comprising performing the fermentation of the grain.

9. The method of claim 1, wherein the compressing of the CO₂ gas comprises compressing to a pressure of 2900 psig (20 MPa) to 7200 psig (49.6 MPa) and forming the scCO₂ at a temperature of 100° F. (37.8° C.) to 180° F. (82.2° C.).

10. The method of claim 1, wherein the extraction is performed at a pressure of 2900 psig (20 MPa) to 7200 psig (49.6 MPa) and at a temperature of 100° F. (37.8° C.) to 180° F. (82.2° C.).

11. The method of claim 1, wherein the scCO₂ used for the extracting further comprises scCO₂ recycled from the extracting.

12. The method of claim 1, wherein the separating comprises depressurizing the scCO₂, to form a used CO₂ and an extracted oil.

13. The method of claim 1, further comprising sequestering the used CO₂, storing the used CO₂, recycling the used CO₂ for reuse in the method, or a combination thereof.

14. The method of claim 13, further comprising recycling the used CO₂ stream for reuse in the method as a portion of the scCO₂ used for the extracting one or more oils from the spent grain.

15. The method of claim 1, wherein the separating is performed at a pressure of 1000 psig (6.9 MPa) to 2000 psig (13.8 MPa) and at a temperature of 80° F. (26.7° C.) to 200° F. (93.3° C.).

16. A method of extracting one or more oils, the method comprising:
compressing CO₂ to form supercritical CO₂ (scCO₂), and/or collecting scCO₂; and
extracting one or more oils from an oil-bearing material comprising a plant product, algae, a waste product, an animal product, or a combination thereof.

17. The method of claim 16, wherein the CO₂ that is formed and/or the scCO₂ that is collected is produced or available on-site at a site where the extracting is performed.

18. The method of claim 16, wherein the CO₂ that is formed and/or the scCO₂ that is collected is produced or available off-site away from a site where the extracting is performed.

19. The method of claim 16, wherein the CO₂ and/or scCO₂ is formed from chemical manufacture, fuel manufacture, pharmaceutical manufacture, agribusiness, food or beverage manufacture, electricity generation, fermentation of a grain to form a fermented grain that is the oil-bearing material, or a combination thereof.

20. A system for of extracting one or more oils, the method comprising:
a compressor configured to compress CO₂ gas produced by fermentation of a grain, to form supercritical CO₂ (scCO₂), wherein the fermentation of the grain forms a spent grain; and
an extractor configured to extract the one or more oils from the spent grain with the scCO₂; and
a separator configured to depressurize the scCO₂ to separate the oil and the scCO₂.
